(19) United States
(12) Patent Application Publication
(10) Pub. No.: US 2008/0132238 A1
(43) Pub. Date: Jun. 5, 2008

(54) WIRELESS NETWORK HANDOVER APPARATUS, METHOD, AND COMPUTER READABLE MEDIUM FOR DYNAMIC HANDOVER

(75) Inventors: Chih-Chiang Hsieh, Kaohsiung County (TW); Shiann-Tsong Sheu, Taipei (TW); Chih-Chen Yang, Tainan (TW); Hua-Chiang Yin, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/682,609

(22) Filed: Mar. 6, 2007

(30) Foreign Application Priority Data
Nov. 30, 2006 (TW) 095144394

(51) Int. Cl. H04Q 7/20

(52) U.S. Cl. 455/437

(57) ABSTRACT

An apparatus for changing wireless network service receives a signal from a mobile apparatus, and transmits the signal to an apparatus for allocating wireless network service. The apparatus for allocating wireless network service allocates the base stations to the mobile apparatus according to the signal. Therefore, the base stations can efficiently serve the mobile apparatus with available resources of communication.

This application claims priority to Taiwan Patent Application No. 095144394 filed on Nov. 30, 2006 of which the contents are incorporated herein by reference in its entirety. CROSS-REFERENCES TO RELATED APPLICATIONS

Not applicable.

### BACKGROUND OF THE INVENTION

1. Field of the Invention

The present invention relates to a wireless network handover apparatus, a method, and a computer readable medium. More specifically, it relates to a wireless network handover apparatus, a method, and a computer readable medium for dynamically controlling and processing handover.

2. Descriptions of the Related Art

With popular and various applications of every kind of electric wireless apparatuses, it is obvious that a wireless apparatus often provides different kinds of services simultaneously. Here a mobile phone is used as an example. Currently, most mobile phones provide the functionality of internet access. Consequently, while a user is calling for talk, the user is possibly downloading data using a FTP (File Transfer Protocol) or sending a short message by using the mobile phone simultaneously. Therefore, the same mobile phone provides three kinds of service at the same time. When the mobile phone leaves the signal coverage range of a base station and enters another signal coverage range of another base station, a handover operation is required to prevent various kinds of data transmission of the mobile phone from interrupted.

FIG. 1 shows a schematic diagram of the conventional handover architecture for a mobile phone 1. The conventional handover architecture comprises a base station 10, a base station 11, a base station 12 and a mobile phone 13. In the conventional example, the base station 10 and the base station 11 can provide three kinds of services such as an speech communication Cl, a data communication C2 and a short message service C3, while the base station 12 can only provide the speech communication Cl and the short message service C3.

At first, the mobile phone 13 is within the signal coverage range of services provided by the base station 10. Therefore, the base station 10 provides a connection 14 for the mobile phone 13. By utilizing the connection 14, the mobile phone 13 uses three kinds of services. When the mobile phone 13 moves to the signal coverage ranges of the base station 11 and the base station 12 along a moving path 15, a connection 16 between the base station 11 and the mobile phone 13 is built if the base station 11 can provide a better servo quality. Then the mobile phone 13 can use the services provided by the base station 11 via the connection 16.

If the mobile phone 13 continuously moves along the moving path 15, the mobile phone 13 will leave the service signal coverage range of the base station 10 gradually and the communication signal quality between the mobile phone 13 and the base station 10 is getting worse. When the mobile phone 13 is located at a position that only the base station 12 can provide services, and the base station 12 has not enough resources to provide three kinds of services simultaneously, the original speech communication Cl, data communication C2 and short message service C3 built between the mobile phone 13 and the base station 13 will be interrupted simultaneously until entering the signal coverage range of the base station 11. Only if the resources of the base station 11 was enough for simultaneously providing the speech communication C1, the data communication C2 and the short message service C3, the mobile phone 13 can reuse three services provided by the base station 11 via the connection 16. From the aforementioned example, all base stations must provide the required resources of services C1, C2 and C3 simultaneously to perform handover in the conventional handover architecture for a mobile phone 1. This leads to inconvenient that the speech communication is forced to be interrupted possibly due to bad overlapping of the signal coverage ranges among base stations while the user is using the speech communication service. Consequently, how to switch services dynamically to different base station according to connection intensity, such as the speech communication C1 being provided by the base station 12, the data communication C2 and the short message service C1 being provided by the base station 10, to effectively utilize resources of each base station and to prevent user required services from interrupted as possible to further enhance utilization ratios of all base stations is still an objective for the industry to endeavor.

### SUMMARY OF THE INVENTION

One objective of this invention is to provide a handover control method of a wireless network, comprising steps of: receiving a report signal from a first service group; determining whether the first service group needs update according to the report signal; transmitting a reservation signal to a second service group for reserving the reservation resources of the second service group; and transmitting an allocation signal to the first service group and the second service group for indicating the handover; wherein each of the first service group and the second service group comprises a plurality of base stations for providing the services to a wireless apparatus.

Another objective of this invention is to provide a handover control apparatus of a wireless network. The handover control apparatus comprises a receiving module and a transmitting module. The receiving module is used for receiving a report signal from a first service group and determining whether the first service group needs update according to the report signal. The transmitting module is used for transmitting a reservation signal to a second service group to reserve the service resources of the second service group and transmitting an allocation signal to the first service group and the second service group to indicate the handover. Wherein, each of the first service group and the second service group comprises a plurality of base stations for providing the services to a wireless apparatus.

Yet a further objective of the invention is to provide a computer readable medium for storing a computer program. The computer program makes a handover control apparatus of a wireless network execute a handover control method of a wireless network. The method comprises steps of: receiving a report signal by a receiving module, wherein the report signal is from a first service group; determining whether the first service group needs update according to the report signal by the receiving module; transmitting a reservation signal to a second service group for reserving the reservation resources of the second service group by a transmitting module; and transmitting an allocation signal to the first service group and the second service group for indicating the handover by the transmitting module; wherein each of the first service group and the second service group comprises a plurality of base stations for providing the services to a wireless apparatus.

Yet a further objective is to provide a handover method of changing a wireless network service, comprising steps of: receiving a reservation signal; transmitting a notice signal to a wireless apparatus according to the reservation signal; receiving an allocation signal; and determining whether the wireless network services of the wireless apparatus needs to be changed according to the allocation signal.

Yet a further objective is to provide a handover apparatus of changing a wireless network service, comprising a receiving module, a transmitting module and a determining module. The receiving module is used for receiving a reservation signal and an allocation signal. The transmitting module is used for transmitting a notice signal to a wireless apparatus according to the reservation signal. The determining module is used for determining whether the wireless network services of the wireless apparatus needs to be changed according to the allocation signal.

Yet a further objective is to provide a computer readable medium for storing a computer program. The computer program makes a handover apparatus of a wireless network execute a handover method of a wireless network. The method comprises steps of: receiving a reservation signal by a receiving module; transmitting a notice signal to a wireless apparatus according to the reservation signal by a transmitting module; receiving an allocation signal by the receiving module; and determining whether the wireless network services of the wireless apparatus needs to be changed according to the allocation signal by the determining module.

The invention can effectively solve the problem of the conventional technique which is unable to execute the handover operation dynamically and leads to a drawback that while the user is using the wireless apparatus, the user must wait until the base station confirms all service resources are ready to perform the handover operation. The invention can individually perform the handover for each of the services that are already built by the wireless apparatus to each of the base stations according to the connection intensity of each of the base stations. Not only resources of each of the base stations can be utilized effectively, but also services already built by the wireless apparatus can maintain connection as possible to enhance an overall performance of the base stations.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of conventional handover architecture of a mobile phone;

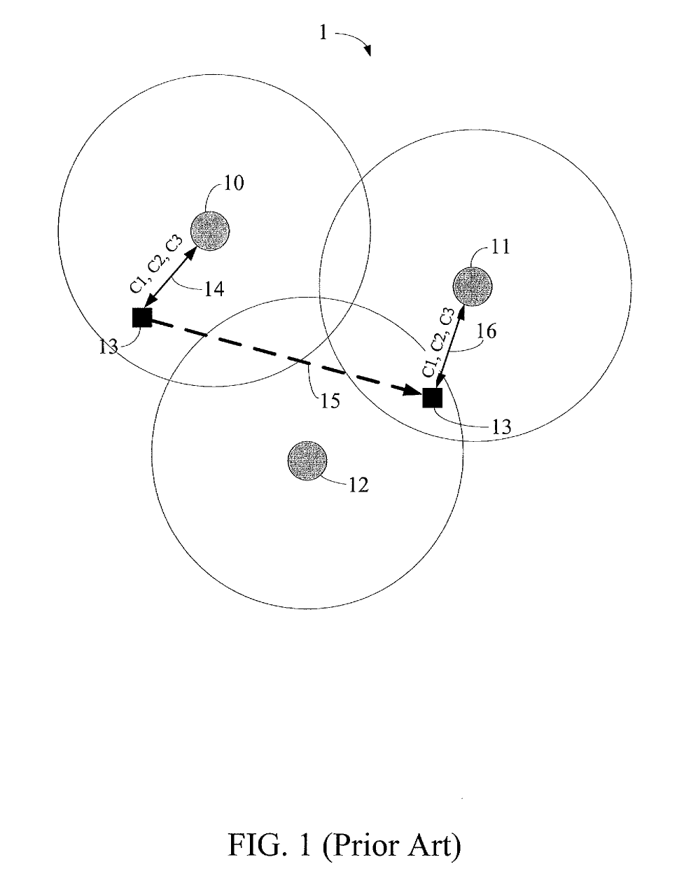

FIG. 2 is a schematic diagram of a first embodiment of the invention;

FIG. 3 is a schematic diagram of a base station of a first embodiment of the invention;

FIG. 4 is a schematic diagram of a base control station of a first embodiment of the invention;

FIG. 5 is a schematic diagram of a second embodiment of the invention;

FIG. 6 is a schematic diagram of a third embodiment of the invention;

FIG. 7 is a schematic diagram of a fourth embodiment of the invention;

FIG. 8A is a flow chart of a fifth embodiment of the invention;

FIG. 8B is a flow chart of a fifth embodiment of the invention;

FIG. 8C is a flow chart of a fifth embodiment of the invention;

FIG. 8D is a flow chart of a fifth embodiment of the invention;

FIG. 9A is a flow chart of a sixth embodiment of the invention;

FIG. 9B is a flow chart of a sixth embodiment of the invention;

FIG. 9C is a flow chart of a sixth embodiment of the invention;

FIG. 10A is a flow chart of a seventh embodiment of the invention;

FIG. 10B is a flow chart of a seventh embodiment of the invention;

FIG. 10C is a flow chart of a seventh embodiment of the invention;

FIG. 11A is a flow chart of an eighth embodiment of the invention;

FIG. 11B is a flow chart of an eighth embodiment of the invention;

FIG. 11C is a flow chart of an eighth embodiment of the invention;

FIG. 12A is a flow chart of a ninth embodiment of the invention;

FIG. 12B is a flow chart of a ninth embodiment of the invention;

FIG. 12C is a flow chart of a ninth embodiment of the invention;

FIG. 12D is a flow chart of a ninth embodiment of the invention;

FIG. 13A is a flow chart of a tenth embodiment of the invention;

FIG. 13B is a flow chart of a tenth embodiment of the invention;

FIG. 13C is a flow chart of a tenth embodiment of the invention;

FIG. 14A is a flow chart of an eleventh embodiment of the invention;

FIG. 14B is a flow chart of an eleventh embodiment of the invention;

FIG. 14C is a flow chart of an eleventh embodiment of the invention;

FIG. 15A is a flow chart of a twelfth embodiment of the invention;

FIG. 15B is a flow chart of a twelfth embodiment of the invention; and

FIG. 15C is a flow chart of a twelfth embodiment of the invention.

### DESCRIPTION OF THE PREFERRED EMBODIMENT

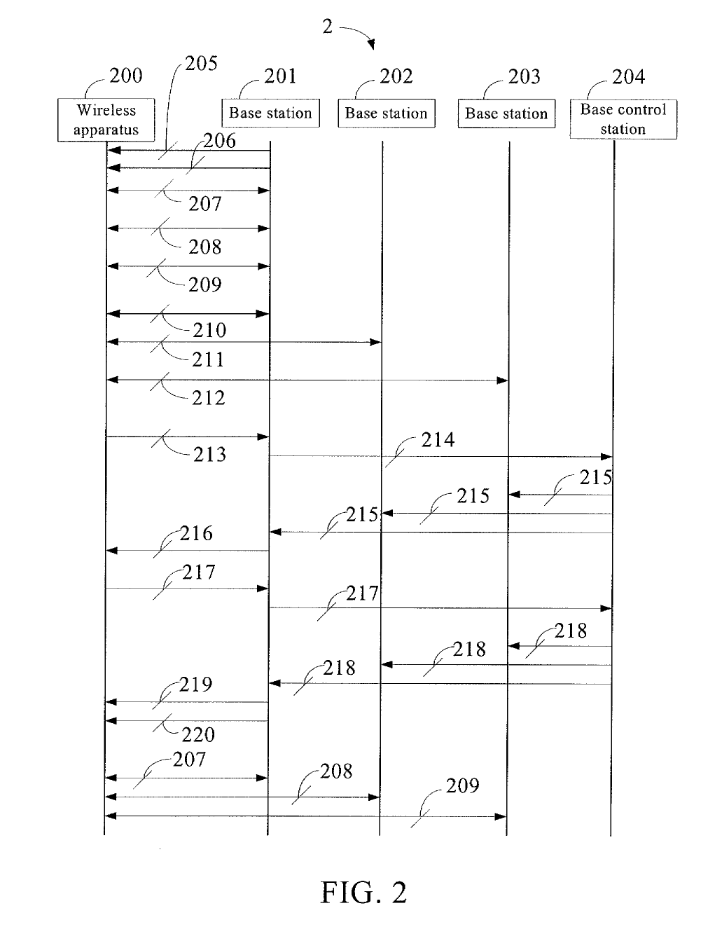

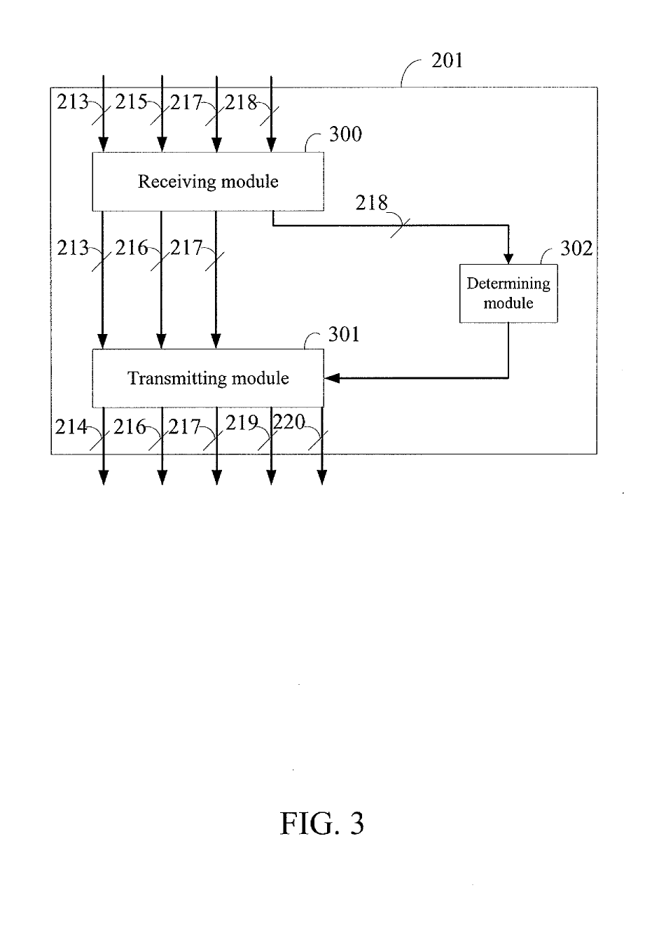

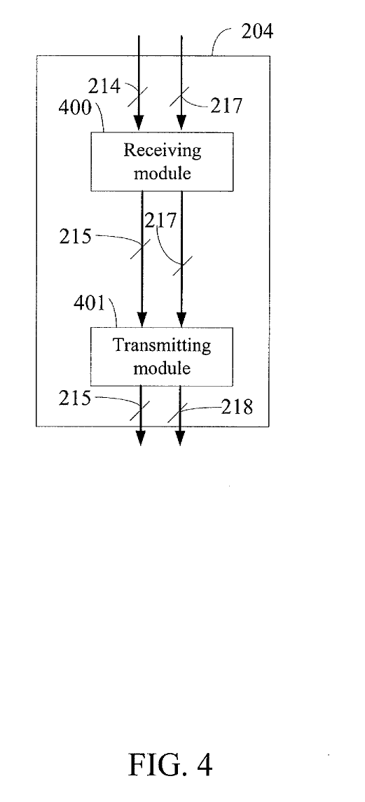

A first embodiment of the invention is shown in FIG. 2 which is a schematic diagram of a handover system 2 of a WiMAX wireless network. The system comprises a wireless apparatus 200, a base station 201, a base station 202, a base station 203 and a base control station 204. As shown in FIG. 3, each of the base stations 201, 202 and 203 comprises a receiving module 300, a transmitting module 301, and a determining module 302. As shown in FIG. 4, the base control station 204 comprises a receiving module 400 and a transmitting module 401.

Rerferring to FIG. 2, in this embodiment, the base station 201 is a main base station providing an upload signal 205 and a download signal 206 for the wireless apparatus 200. The upload signal 205 comprises all required information for uploading and the download signal 206 comprises all required information for downloading. The wireless apparatus 200 must obtain the information to achieve communications with the base station 201, the base station 202 and the base station 203. Detailed contents of the upload signal 205 and the download signal 206 are conforming to a WiMAX wireless network specification and no further descriptions are given here.

In the first embodiment, three services simultaneously provided by one base station are distributed to three different base stations via the handover operation. Under an initial state, the base station 201 provides three connection services 207, 208 and 209 for the wireless apparatus 200. At this time, a first service group that provides services for the wireless apparatus 200 comprises only the base station 201. Next, the wireless apparatus 200 transmits measurement signals 210, 211 and 212 to detect connection intensity of the base station 201, 202 and 203 respectively, wherein a technique for detecting the connection intensity is conforming to the WiMAX wireless network specification and no further descriptions are given here. After obtaining the connection intensity information for each of the base stations, the wireless apparatus 200 can change communication to the base station that provides services according to the connection intensity information of each of the base stations. Consequently, the wireless apparatus 200 transmits a handover request signal 213 to the base station 201, wherein the handover request signal 213 comprises the information of connection intensity of the wireless network, a service bandwidth, and a data linking priority of the wireless apparatus. The base station 201 receives the handover request signal 213 via the receiving module 300 and the transmitting module 301 transmits a first report signal 214 to the base control station 204 according to the content of the handover request signal 213.

Referring to FIG. 4, the base control station 204 receives the first report signal 214 via the receiving module 400 and determines whether a request of the report signal 214 can be met according to the information of the connection intensity of the wireless network, the service bandwidth, and the data linking priority of the wireless apparatus in the first report signal 214. For convenient understanding, the connection intensity and a remaining resource are denoted as numbers in the following, and the wireless apparatus is located at a position that all the base stations 201, 202 and 203 can provide services. Assume that connection intensity of the wireless network of the base station 201 is 5 and its remaining resource is 2, connection intensity of the wireless network of the base station 202 is 10 and its remaining resource is 5, and connection intensity of the wireless network of the base station 203 is 15 and its remaining resource is 3; and the required resources and priorities of the connection services 207, 208 and 209 of the wireless apparatus are (6,3), (4,1) and (2,2) respectively. The priority with a smaller value means higher priority and the connection intensity of the wireless network with a larger value means stronger connection intensity.

At first, considering ordering of the priorities. The service 207, the service 208 and the service 209 are respectively distributed to the base station 201, the base station 203 and the base station 202 that provide services. Next, considering whether the remaining resources are enough for providing corresponding services for each of the base stations. Consequently, the receiving module 400 of the base control station finally distributes the service 207, the service 208 and the service 209 to the base station 201, the base station 202 and the base station 203 respectively, and generates a reservation signal 215. The transmitting module 401 transmits the reservation signal 215 to all base stations that provide services so that all base stations that provide services reserve necessary resources for providing services. In the first embodiment, all base stations that provide services are the base station 201, the base station 202 and the base station 203. After the base station 201 receives the reservation signal 215 via the receiving module 300, the transmitting module 301 transmits a notice signal 216 to the wireless apparatus 200 according to the reservation signal 215 so that the wireless apparatus 200 receives a distributing result of the base control station 204.

Please refer to FIG. 2 continuously. After the wireless apparatus 200 receives the notice signal 216, it determines whether to accept the distributing result of the base control station 204. If no, the handover request signal 213 is transmitted continuously. If yes, the distributing result of the base control station 204 is accepted and a decision signal 217 is transmitted to the base station 201 and the base station 201 transmits the decision signal 217 to the base control station 204. After the base control station 204 receives the decision signal 217 via the receiving module 400, the receiving module 400 determines whether the wireless apparatus 200 accepts the distributing result according to the decision signal 217. If no, the reserved resources on each base station are not allocated. If yes, the transmitting module 401 transmits an allocation signal 218 to all base stations that provide services. After all base stations receive corresponding allocation signal 218 via corresponding receiving module, all base stations that provide services allocate the reserved resources. For the base station 201 as an example, the determining module 302 determines whether the base station 201 is the main base station according to the allocation signal 218. If no, the upload signal 219 and the download signal 220 are stopped transmitting to the wireless apparatus 200. If yes, the base station 201 retransmits the upload signal 219 and the download signal 220 to the wireless apparatus 200 so that the wireless apparatus 200 can receive uploading and downloading conditions of each of the base stations. Finally, services 207, 208 and 209 are separately provided by base stations 201, 202 and 203 to complete the handover operation. After completing the handover operation, base stations 201, 202 and 203 that provide services for the wireless apparatus 200 are called a second service group.

In the first embodiment, if the handover request signal 213 comprises the information of connection intensity only, the base control station 204 can actively inform the wireless apparatus 200 via the reservation signal 215 to perform the handover operation for adjusting base stations that provide services 207, 208 and 209.

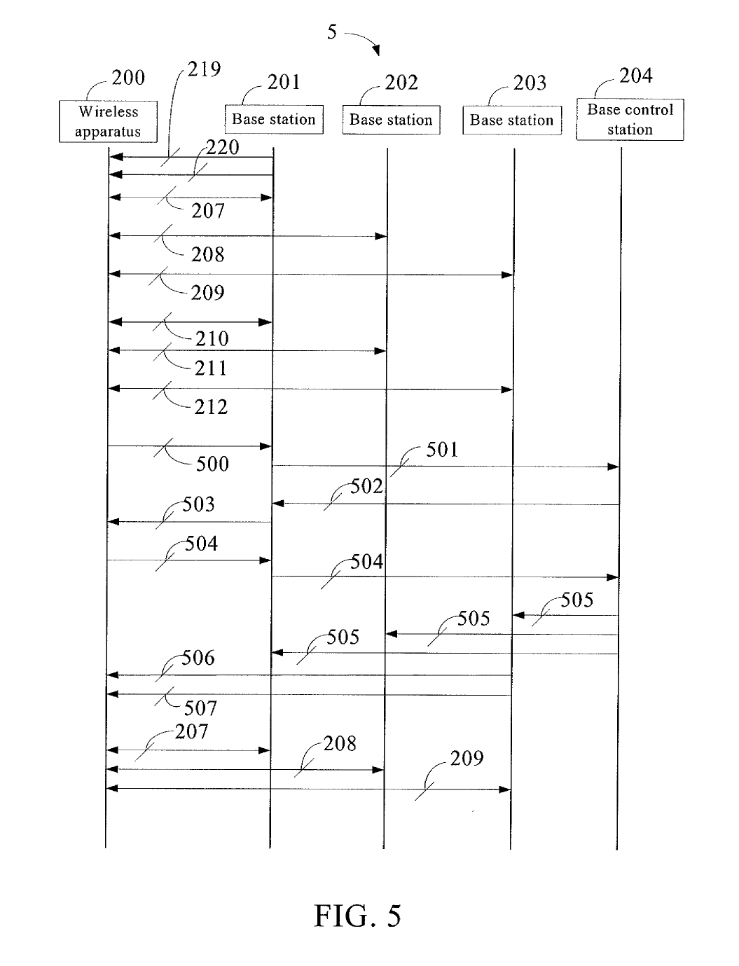

A second embodiment of the invention is shown in FIG. 5 which is a wireless network handover system S conforming to the WiMAX specification. The system comprises a wireless apparatus 200, a base station 201, a base station 202, a base station 203 and a base control station 204. In the second embodiment, a main base station is changed from the base station 201 to the base station 203 via the handover operation, and an initial state is that services 207, 208 and 209 are provided by base stations 201, 202 and 203 respectively. The main base station is the base station 201.

At first, the wireless apparatus 200 transmits a handover request signal 500 to the base station 201. After the base station 201 receives the handover request signal 500, a first report signal 501 is transmitted to the base control station 204. The base control station 204 determines whether to accept a request of the first report signal 501 according to the information of connection intensity of the wireless network, a service bandwidth and a data linking priority of the wireless apparatus in the first report signal 501. If the request of the first report signal 501 is accepted, a reservation signal 502 is transmitted to the base station 201. According to the reservation signal 502, the base station 201 transmits a notice signal 503 to the wireless apparatus 200 so that the wireless apparatus 200 gets a distributing result of the base control station 204.

After the wireless apparatus 200 receives the notice signal 503, it determines whether to accept the distribution result of the base control station 204. If no, the wireless apparatus 200 continuously transmits the handover request signal 500. If yes, the distributing result of the base control station 204 is accepted and a decision signal 504 is transmitted to the base station 201. The base station 201 then transmits the decision signal 504 to the base control station 204. The base control station 204 determines whether the wireless apparatus 200 accepts the distributing result of the base control station 204 according to the decision signal 504. If no, the main base station is still the base station 201. If yes, the base control station 204 transmits an allocation signal 505 to all the base stations so that all the base stations confirm that the main base station is changed from the base station 201 to the base station 203.

Next, the base station 203 transmits an upload signal 506 and a download signal 507 to the wireless apparatus 200 so that the wireless apparatus 200 recognizes uploading and downloading conditions for each of the base stations. Finally, services 207, 208 and 209 are provided by base stations 201, 202 and 203 respectively.

In the second embodiment, if the handover request signal 500 comprises the information of connection intensity only, the base control station 204 can actively inform the wireless apparatus 200 via the reservation signal 502 to perform the handover operation for adjusting the main base station that provides the upload signal 506 and the download signal 507.

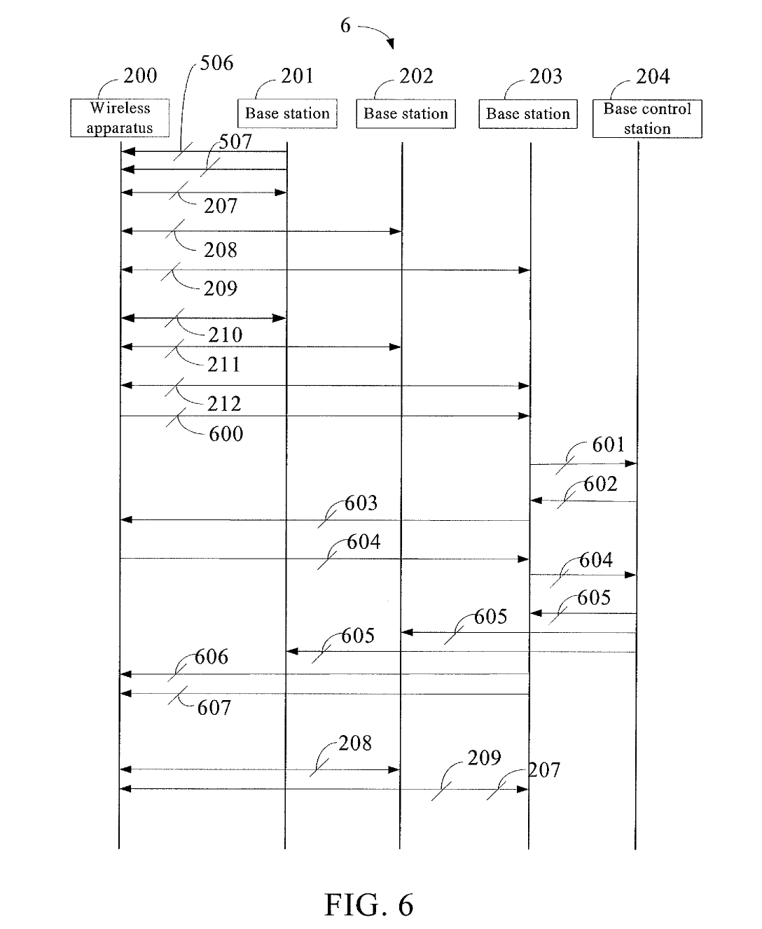

A third embodiment of the invention is shown in FIG. 6 which is a wireless network handover system 6 conforming to the WiMAX specification. The system comprises a wireless apparatus 200, a base station 201, a base station 202, a base station 203 and a base control station 204. In the third embodiment, the base station 201 is changed to the base station 203 via the handover operation to provide the service 207 as an example, and an initial state is that services 207, 208 and 209 are provide by base stations 201, 202 and 203 respectively. A main base station is the base station 203.

When the wireless apparatus 200 transmits a handover request signal 600 to the base station 203 and after the base station 203 receives the handover request signal 600, the base station 203 transmits a first report signal 601 to the base control station 204. The base control station 204 determines whether to accept a request of the first report signal 601 according to the information of connection intensity of the wireless network, a service bandwidth and a data linking priority of the wireless apparatus in the first report signal 601. If the request of the first report signal 601 is accepted, the base station 204 transmits a reservation signal 602 to the base station 203.

According to the reservation signal 602, the base station 203 transmits a notice signal 603 to the wireless apparatus 200 so that the wireless apparatus 200 receives a distributing result of the base control station 204.

After the wireless apparatus 200 receives the notice signal 603, it determines whether to accept the distribution result of the base control station 204. If no, the handover request signal 600 is transmitted continuously. If yes, the distributing result of the base control station 204 is accepted and the wireless apparatus 200 transmits a decision signal 604 to the base station 203. The base station 203 then transmits the decision signal 604 to the base control station 204. The base control station 204 determines whether the wireless apparatus 200 accepts the distributing result of the base control station 204 according to the decision signal 604. If no, all base stations that provide services are remained the same. If yes, the base control station 204 transmits an allocation signal 605 to all the base stations to inform all base stations that the service 207 will be changed from the base station 201 to the base station 203 for providing. Later, the base station 203 transmits an upload signal 606 and a download signal 607 to the wireless apparatus 200 so that the wireless apparatus 200 recognizes current uploading and downloading conditions of each of the base stations. Finally, the base station 203 provides services 207 and 209 and the base station 202 provides the service 208 for the wireless apparatus 200.

In the third embodiment, if the handover request signal 600 comprises the information of connection intensity only, the base control station 204 can actively inform the wireless apparatus 200 via the reservation signal 602 to perform the handover operation for adjusting the base station that provides services 207, 208 and 209.

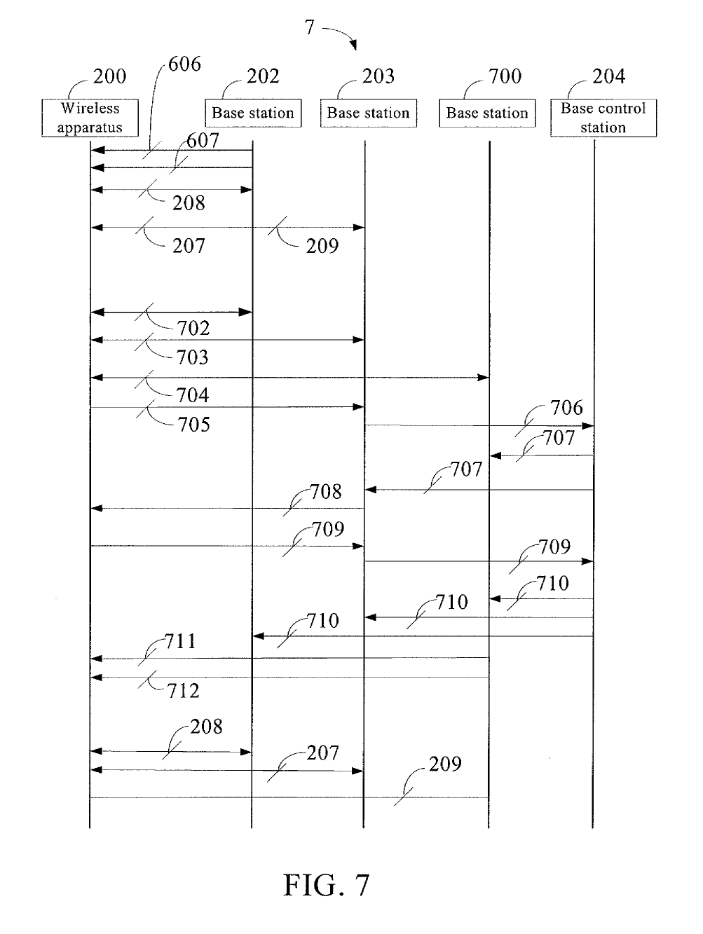

A fourth embodiment of the invention is shown in FIG. 7 which is a wireless network handover system 7 conforming to the WiMAX specification. The system comprises a wireless apparatus 200, a base station 700, a base station 202, a base station 203 and a base control station 204, wherein the base station 700 is the same as the base station 202 and the base station 203.

In the fourth embodiment, the base station 203 is changed to the newly added base station 700 via the handover operation to provide the service 209, and an initial state is that services 207 and 209 are provide by the base station 203, and the service 208 is provided by the base station 202. A main base station is the base station 203.

At first, the wireless apparatus 200 detects the signal of the base station 700 and thus the wireless apparatus 200 transmits measurement signals 702, 703 and 704 to detect connection intensity of base stations 202, 203 and 700 respectively. After obtaining the connection intensity information of each of base stations, the wireless apparatus 200 can change the base station that provides services according to connection intention information of each of base stations. Consequently, the wireless apparatus 200 transmits a handover request signal 705 to the base station 203. After the base station 203 receives the handover request signal 705, it transmits a first report signal 706 to the base control station 204. The base control station 204 determines whether to accept a request of the first report signal 706 according to the information of connection intensity of the wireless network, a service bandwidth and a data linking priority of the wireless apparatus in the first report signal 706. If the request of the first report signal 706 is accepted, a reservation signal 707 is transmitted to the base station 203 and the base station 700 to reserve the required resources for providing services. Furthermore, according to the reservation signal 707, the base station 203 transmits a notice signal 708 to the wireless apparatus 200 so that the wireless apparatus 200 receives a distributing result of the base control station 204.

After the wireless apparatus 200 receives the notice signal 708, it determines whether to accept the distribution result of the base control station 204. If no, the handover request signal 705 is transmitted continuously. If yes, the distributing result of the base control station 204 is accepted and a decision signal 709 is transmitted to the base station 203. The base station 203 then transmits the decision signal 709 to the base control station 204. The base control station 204 determines whether the wireless apparatus 200 accepts the distributing result of the base control station 204 according to the decision signal 709. If no, all base stations that provide services are remained the same. If yes, the base control station 204 transmits an allocation signal 710 to all the base stations to inform all base stations that the service 209 will be changed from the base station 203 to the base station 700 for providing. Later, the base station 700 transmits an upload signal 711 and a download signal 712 to the wireless apparatus 200 so that the wireless apparatus 200 recognizes current uploading and downloading conditions of each of the base stations. Finally, the base station 203 provides the services 207, the base station 202 provides the service 208, and the base station 700 provides the service 209.

In the fourth embodiment, if the handover request signal 705 comprises the information of connection intensity only, the base control station 204 can actively inform the wireless apparatus 200 via the reservation signal 707 to perform the handover operation for adjusting the base station that provides services 207, 208 and 209.

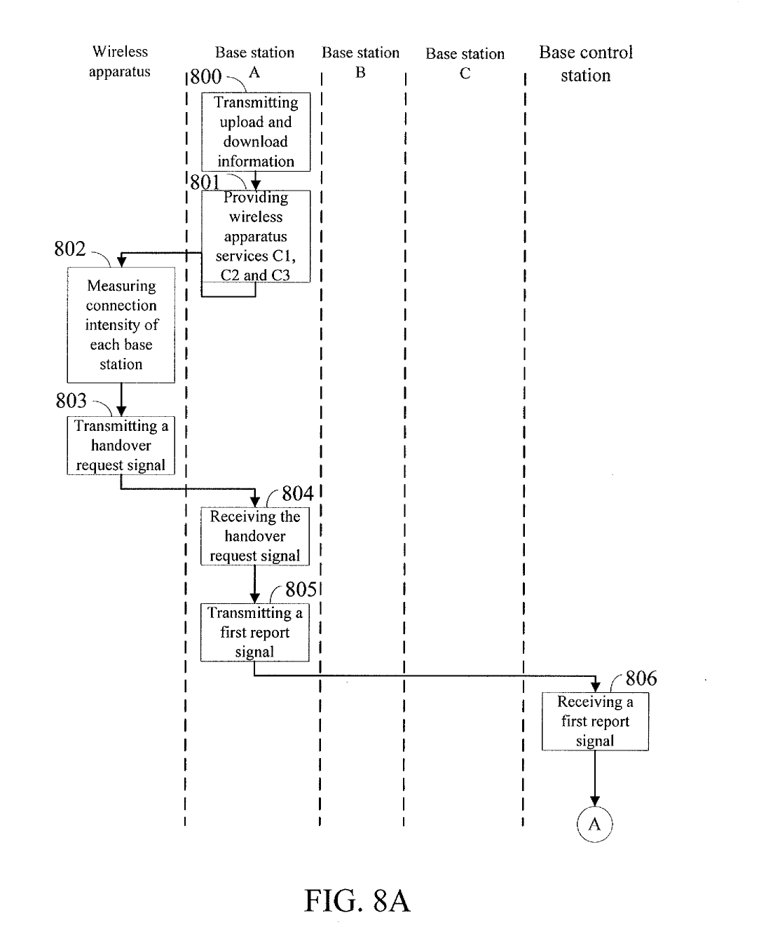

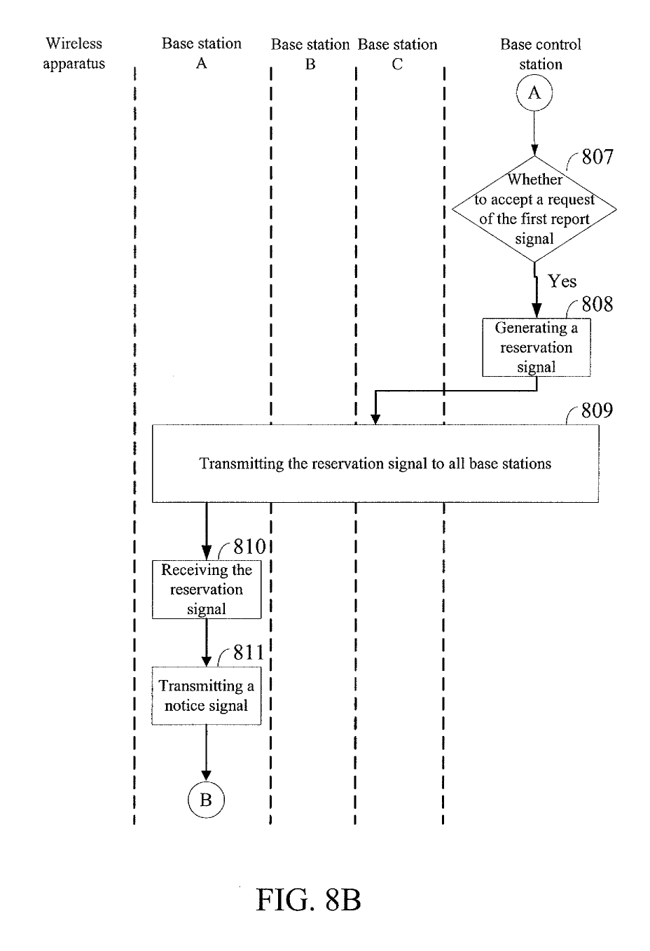

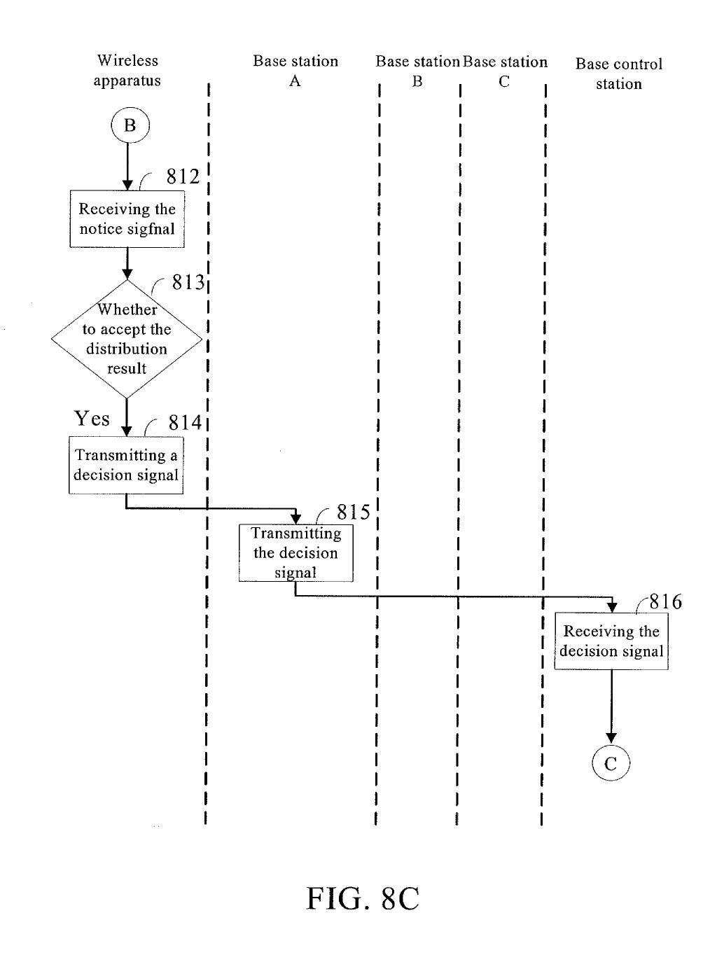

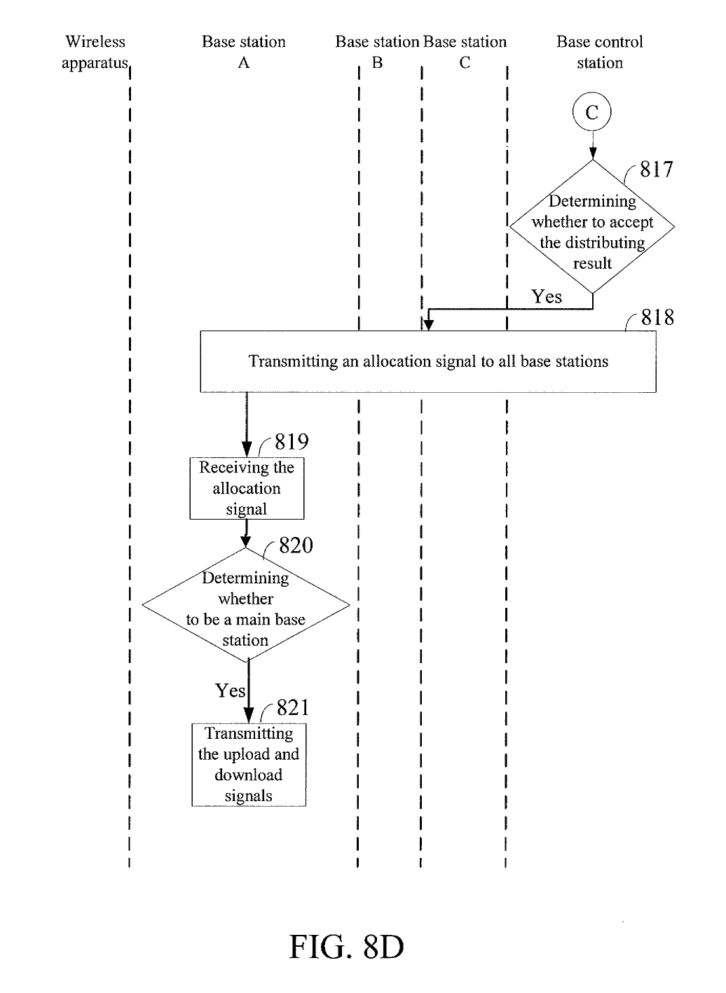

A fifth embodiment of the invention is shown in FIG. 8A, 8B, 8C and 8D which are flow charts of a handover control method of a wireless network handover system conforming to the WiMAX specification. The handover system comprises a wireless apparatus, a base station A, a base station B, a base station C and a base control station. Assume that the base station A is a main base station. Consequently, step 800 is executed for providing an upload signal and a download signal to the wireless apparatus, wherein the upload signal comprises all necessary information related to uploading and the download signal comprises all necessary information related to downloading. When the wireless apparatus obtains the necessary information, it is able to communicate with the base station A, the base station B and the base station C. Detailed contents of the upload signal and the download signal are signals conforming to the WiMAX wireless network specification and no further descriptions are given here.

Later, the base station A executes step 801 for providing services C1, C2 and C3 for the wireless apparatus. In the fifth embodiment, three services simultaneously provided by the base station A are switched to the base station B and the base station C via the handover operation. Step 802 is executed for transmitting measurement signals to detect connection intensity of base stations A, B and C that provide services for the wireless apparatus, wherein a technique for detecting connection intensity conforms to the WiMAX wireless network specification and no further descriptions are given here. After receiving the connection intensity information of each base station, the wireless apparatus can change the base station that provides service according to the connection intensity information of each base station. Consequently, step 803 is executed for transmitting a handover request signal to the base station A, wherein the handover request signal comprises the information of connection intensity of the wireless network, a service bandwidth and a data linking priority of the wireless apparatus. Step 804 is executed for receiving the handover request signal by the base station A. Later, step 805 is executed for transmitting a first report signal from the base station A to the base control station according to the content of the handover request signal 213.

Step 806 is executed for receiving the first report signal by the base control station. Next, step 807 is executed for determining whether to accept a request of the first report signal according to the information of the connection intensity of the wireless network, the service bandwidth and the data linking priority of the wireless network. In the following, the connection intensity and the remaining resources are represented as numbers for convenience of understanding, and the wireless apparatus is just located within a range that base stations A, B and C can provide services. For example, connection intensity of the wireless network of the base station A is 5 and its remaining resource is 2, connection intensity of the wireless network of the base station B is 10 and its remaining resource is 5, and connection intensity of the wireless network of the base station C is 15 and its remaining resource is 3; and the required resources and the priorities of the connection services C1, C2 and C3 of the wireless apparatus are (6,3), (4,1) and (2,2) respectively. In the fifth embodiment, the priority with a smaller value means higher priority and the connection intensity of the wireless network with a larger value means stronger connection intensity. At first, considering ordering of the priorities. The service C1, the service C2 and the service C3 are distributed to the base station A, the base station B and the base station C respectively Next, step 807 is executed for determining whether the remaining resources of each base station are enough for providing corresponding services to distribute the service C1, the service C2 and the service C3 to the base station A, the base station B and the base station C respectively. Next, step 808 is executed for generating a reservation signal. Later, step 809 is executed for transmitting the reservation signal to all base stations that provide services so that all base stations that provide services reserve necessary resources of services for providing. In the fifth embodiment, all base stations providing services are the base station A, the base station B, and the base station C.

Step 810 is executed to enable the base station A for receiving the reservation signal. Next, step 811 is executed for transmitting a notice signal to the wireless apparatus according to the reservation signal so that the wireless apparatus receives a distributing result of the base control station. Step 812 is executed to enable the wireless apparatus for receiving the distributing result of the base control station. Step 813 is executed for deciding whether to accept the distributing result of the base control station. If no, the handover request signal is transmitted continuously. If yes, the distributing result of the base control station is accepted. Next, step 814 is executed for transmitting a decision signal to the base station A. Next, step 815 is executed to enable the base station A for transmitting the decision signal to the base control station. Next, step 816 is executed to enable the base control station for receiving the decision signal. Step 817 is executed for determining whether the wireless apparatus accepts the distributing result of the base control station according to the decision signal. If no, the reserved resources on each base station are not allocated. If yes, step 818 is executed for transmitting an allocation signal to all base stations that provide services (comprising the base station A, the base station B, and the base station C) so that all base stations that provide services allocate the reserved resources. For the base station A as an example, step 819 is executed to enable the base station A for receiving the allocation signal. Later, step 820 is executed for determining whether the base station A is the main base station according to the allocation signal. If no, the upload signal and the download signal are stopped transmitting to the wireless apparatus. If yes, step 821 is executed to enable the base station A for transmitting the upload signal and the download signal to the wireless apparatus so that the wireless apparatus can understand uploading and downloading conditions of each of the base stations. Finally, services C1, C2 and C3 are separately provided by base stations A, B and C to complete the handover operation.

In the fifth embodiment, if the handover request signal comprises the information of connection intensity only, the base control station can actively inform the wireless apparatus via the reservation signal to perform the handover operation for adjusting the base station that provides services C1, C2 and C3.

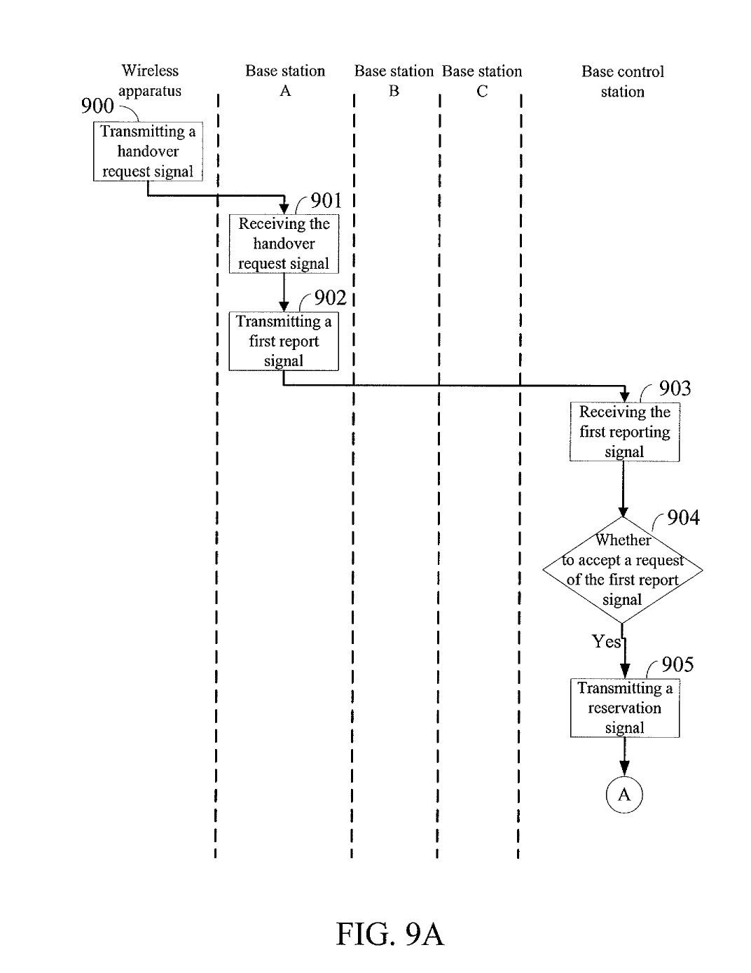

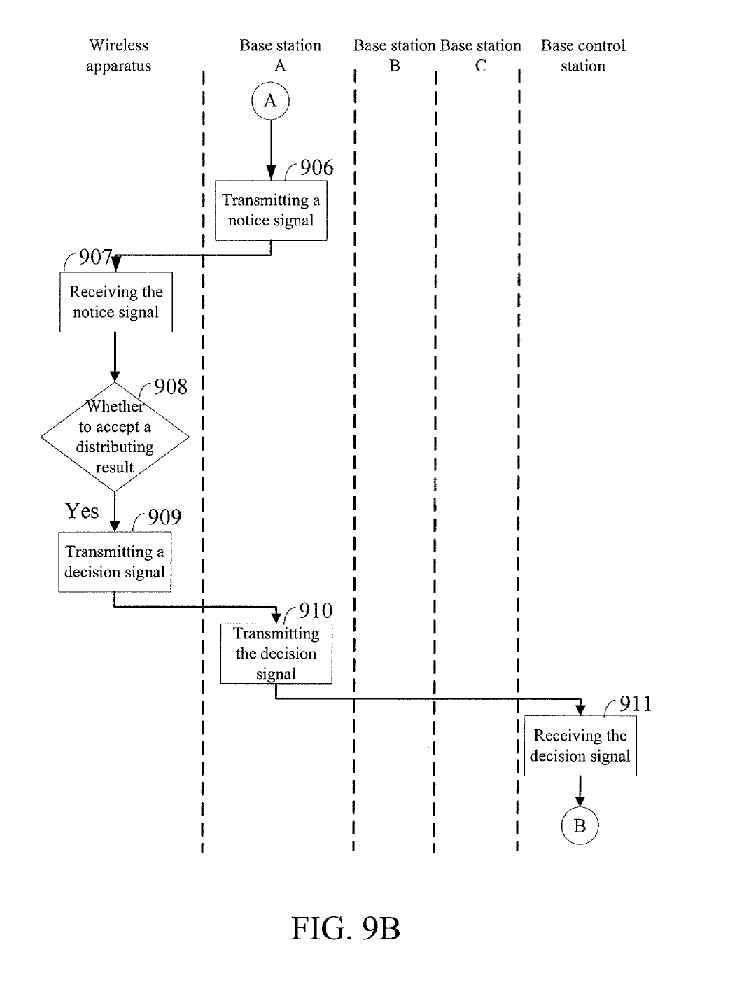

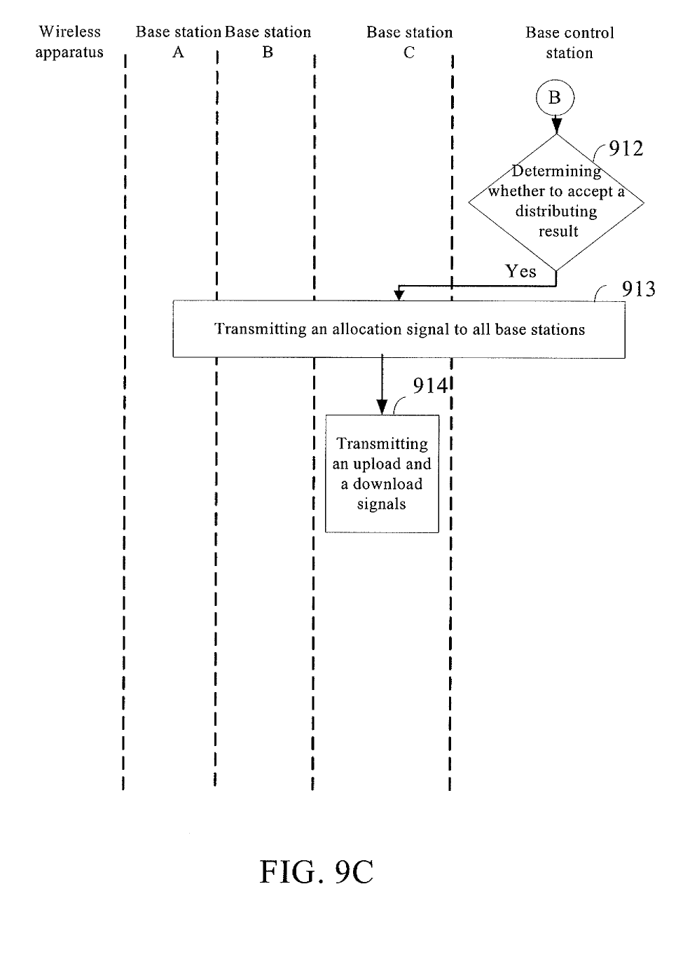

A sixth embodiment of the invention is shown in FIG. 9A, 9B and 9C, which is a flow chart of a handover control method of a wireless network handover system conforming to the WiMAX specification. In the sixth embodiment, a main base station is changed form a base station A to a base station C according to a handover operation as an example, and an initial state is that current services C1, C2 and C3 are provided by base stations A, B and C respectively. The main base station is the base station A.

At first, step 900 is executed to enable the wireless apparatus for transmitting a handover request signal to the base station A. Next, step 901 is executed to enable the base station A for receiving the handover request signal. Step 902 is executed to enable the base station A for transmitting a first report signal to the base control station. Next, step 903 is executed to enable the base control station for receiving the first report signal. Step 904 is executed for determining whether to accept a request of the first report signal according to the information of connection intensity of the wireless network, a service bandwidth and a data linking priority of the wireless apparatus in the first report signal. If the request of the first report signal is accepted, step 905 is executed for transmitting a reservation signal to the base station A. Next, step 906 is executed to enable the base station A for transmitting a notice signal to the wireless apparatus according to the reservation signal by the base station A so that the wireless apparatus gets a distributing result of the base control station.

Next, step 907 is executed to enable the wireless apparatus for receiving the notice signal. Step 908 is executed to enable the wireless apparatus for determining whether to accept the distributing result of the base control station. If no, the handover request signal is transmitted continuously. If yes, the distributing result of the base control station is accepted and step 909 is executed to enable the wireless apparatus for transmitting a decision signal to the base station A. Next, step 910 is executed to enable the base station A for transmitting the decision signal to the base control station. Next, step 911 is executed to enable the base control station for receiving the decision signal, and step 912 is executed for determining whether the wireless apparatus accepts the distributing result of the base control station according to the decision signal. If no, the main base station is still the base station A. If yes, step 913 is executed to enable the base control station for transmitting an allocation signal to all the base stations (comprising the base station A, the base station B and the base station C) so that all base stations know the main base station is changed from the base station A to the base station C.

Next, step 914 is executed to enable the base station C for transmitting an upload signal and a download signal to the wireless apparatus so that the wireless apparatus can understand current uploading and downloading conditions of each base station. Finally, services C1, C2 and C3 are still provided by base stations A, B and C. In the sixth embodiment, if the handover request signal comprises the information of connection intensity only, the base control station can actively inform the wireless apparatus via the reservation signal to perform the handover operation for adjusting the main base station that provides the upload signal and the download signal.

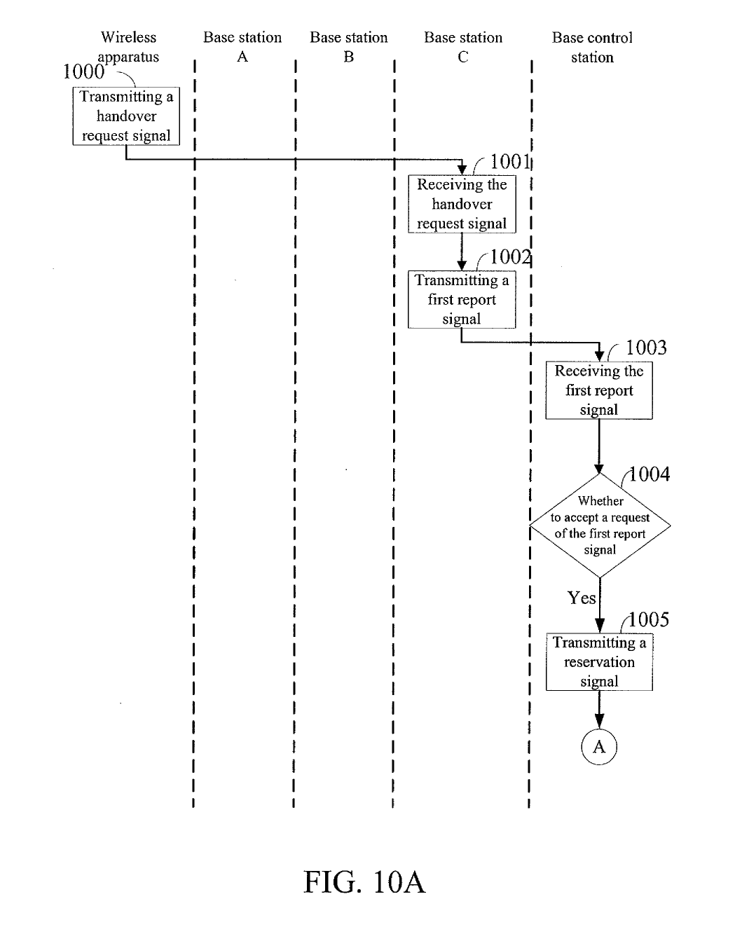

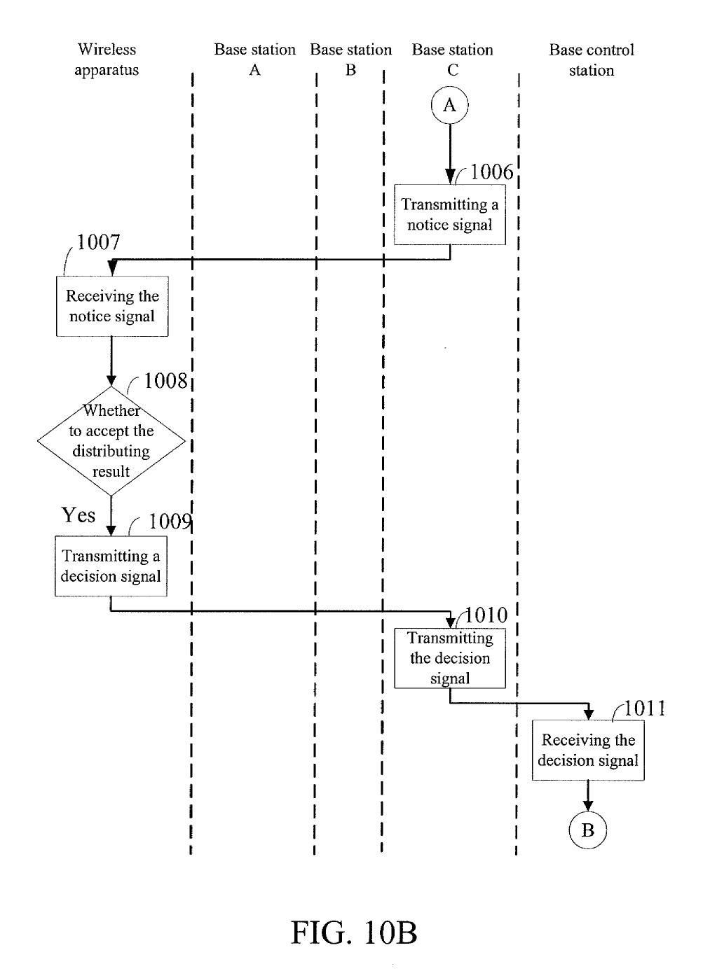

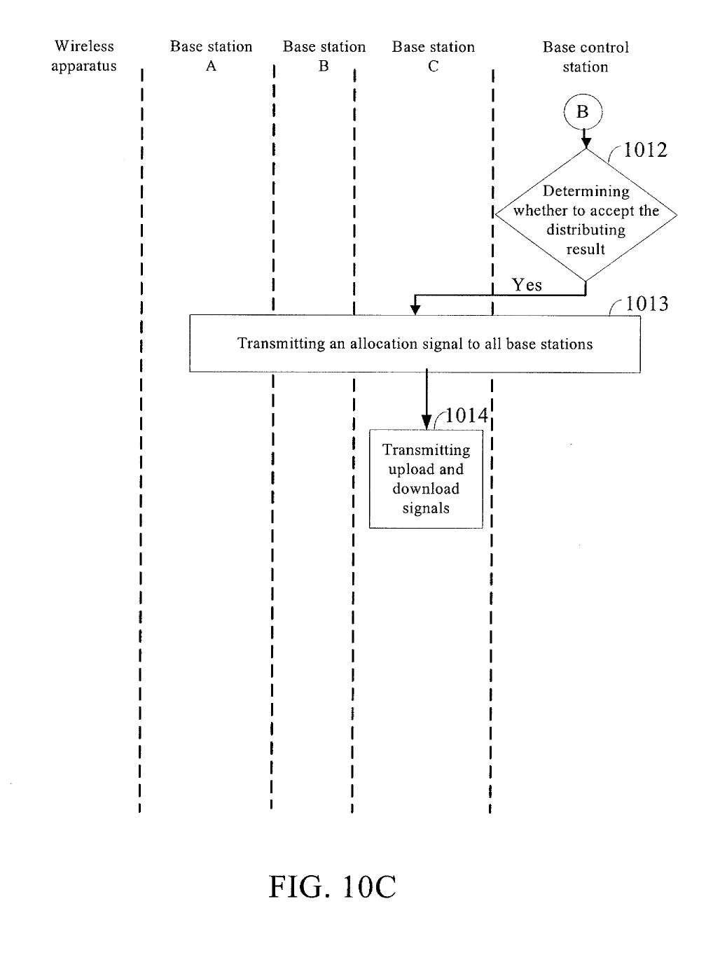

A seventh embodiment of the invention is shown in FIG. 10A, 10B and 10C, which is a flow chart of a handover control method of a wireless network handover system conforming to the WiMAX specification. In the seventh embodiment, a base station A is changed to a base station C to provide a service C1 according to a handover operation as an example, and an initial state is that current services C1, C2 and C3 are provided by base stations A, B and C respectively. A main base station is the base station C.

At first, step 1000 is executed to enable the wireless apparatus for transmitting a handover request signal to the base station C. Next, step 1001 is executed to enable the base station C for receiving the handover request signal. Next, step 1002 is executed for transmitting a first report signal to the base control station. Next, step 1003 is executed to enable the base control station for receiving the first report signal. Step 1004 is executed to enable the base control station for determining whether to accept a request of the first report signal according to the information of connection intensity of the wireless network, a service bandwidth and a data linking priority of the wireless apparatus in the first report signal. If the request of the first report signal is accepted, step 1005 is executed for transmitting a reservation signal to the base station C. Next, step 1006 is executed to enable the base station C for transmitting a notice signal to the wireless apparatus according to the reservation signal so that the wireless apparatus gets a distributing result of the base control station.

Next, step 1007 is executed to enable the wireless apparatus for receiving the notice signal. Step 1008 is executed to enable the wireless apparatus for determining whether to accept the distributing result of the base control station. If no, the handover request signal is transmitted continuously. If yes, the distributing result of the base control station is accepted and step 1009 is executed to enable the wireless apparatus for transmitting a decision signal to the base station C. Next, step 1010 is executed to enable the base station C for transmitting the decision signal to the base control station. Next, step 1011 is executed to enable to base control station for receiving the decision signal, and step 1012 is executed for determining whether the wireless apparatus accepts the distributing result of the base control station according to the decision signal. If no, all base stations that provide services do not change. If yes, step 1013 is executed to enable the base control station for transmitting an allocation signal to all the base stations (comprising the base station B, the base station C and the base station D) so that all base stations know the base station that provides the service C1 is already changed from the base station A to the base station C. Later, step 1014 is executed to enable the base station C for transmitting an upload signal and a download signal to the wireless apparatus so that the wireless apparatus can receive current uploading and downloading conditions of each base station.

Finally, the base station C provides the service C1 and C3, and the base station B provides the service C2.

In the seventh embodiment, if the handover request signal comprises the information of connection intensity only, the base control station can actively inform the wireless apparatus via the reservation signal to perform the handover operation for adjusting base stations that provide services C1, C2 and C3.

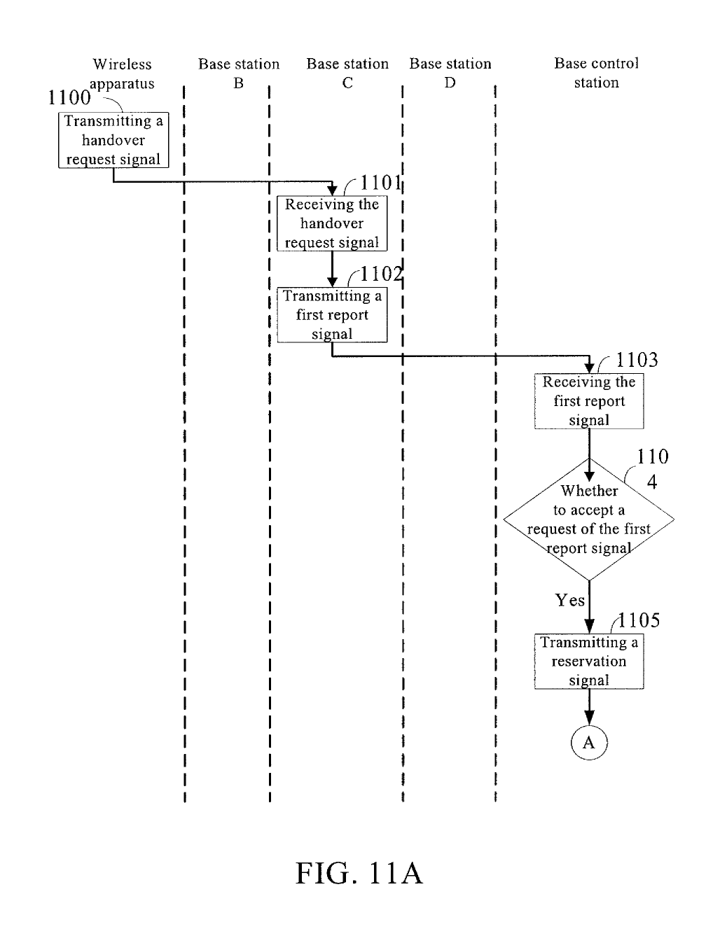

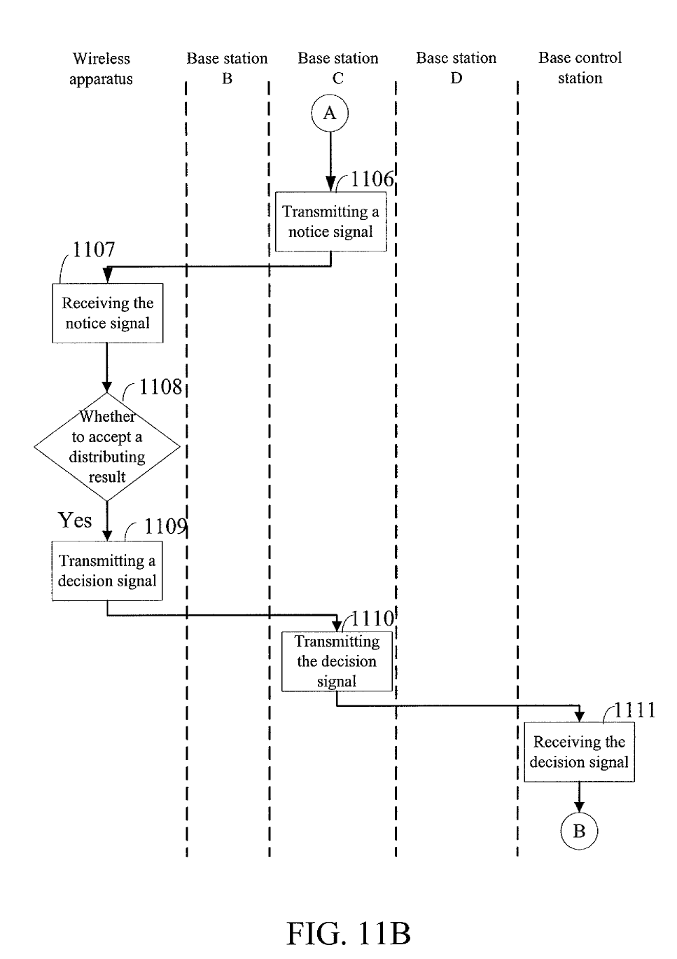

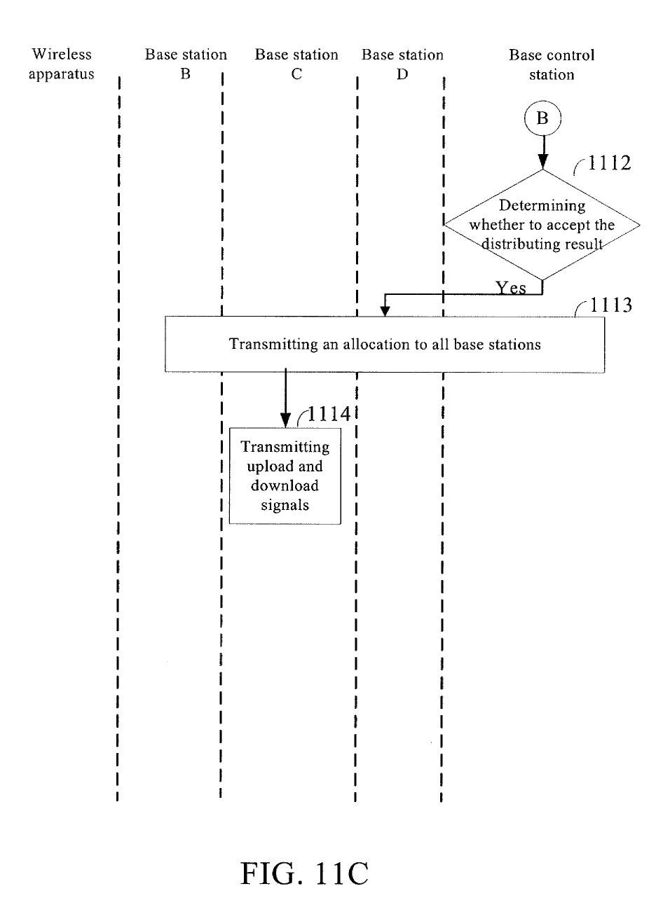

An eighth embodiment of the invention is shown in FIG. 11A, 11B and 11C, which is a flow chart of a handover control method of a wireless network handover system conforming to the WiMAX specification. The defference between the eighth embodiment and the seventh embodiment is that a base station D is newly added as an example for illustrating how to change a base station C that provides a service C3 to the newly added base station D via a handover operation. An initial state is that current services C1 and C3 are provided by the base station C, and a service C2 is provided by a base station B. A main base station is the base station C.

After the wireless apparatus confirms the connection intensity information of the base station B, the base station C and the base station D, the wireless apparatus can change the base station that provides services according to the connection intensity information of each base station. Consequently, the wireless apparatus executes step 1100 for transmitting a handover request signal to the base station C. Next, step 1101 is executed to enable the base station C for receiving the handover request signal. Step 1102 is executed to enable the base station C for transmitting a first report signal to the base control station. Next, step 1103 is executed to enable the base control station for receiving the first report signal. Step 1104 is executed for determining whether to accept a request of the first report signal according to the information of connection intensity of the wireless network, a service bandwidth and a data linking priority of the wireless apparatus in the first report signal by the base control station. If the request of the first report signal is accepted, step 1105 is executed for transmitting a reservation signal to the base station C and the base station D to reserve the required resources for providing services. Next, step 1106 is executed to enable the base station C for transmitting a notice signal to the wireless apparatus according to the reservation signal so that the wireless apparatus gets a distributing result of the base control station.

Next, step 1107 is executed to enable the wireless apparatus for receiving the notice signal. Step 1108 is executed for determining whether to accept the distributing result of the base control station by the wireless apparatus. If no, the handover request signal is transmitted continuously. If yes, the distributing result of the base control station is accepted and step 1109 is executed for transmitting a decision signal to the base station C. Next, step 1110 is executed to enable the base station C for transmitting the decision signal to the base control station. Step 1111 is executed to enable the base control station for receiving the decision signal, and step 1112 is executed for determining whether the wireless apparatus accepts the distributing result of the base control station according to the decision signal. If no, all base stations that provide services do not change. If yes, step 1113 is executed to enable the base control station for transmitting an allocation signal to all the base stations (comprising the base station A, the base station B and the base station C) so that all base stations receive a message of the base station that provides the service C3 is already changed from the base station C to the base station D. Later, step 1114 is executed to enable the base station C for transmitting an upload signal and a download signal to the wireless apparatus so that the wireless apparatus can understand current uploading and downloading conditions of each base station. Finally, the base station C provides the service C1, the base station B provides the service C2, and the base station D provides the service C3.

In the eighth embodiment, if the handover request signal comprises the information of connection intensity only, the base control station can actively inform the wireless apparatus via the reservation signal to perform the handover operation for adjusting base stations that provide services C1, C2 and C3.

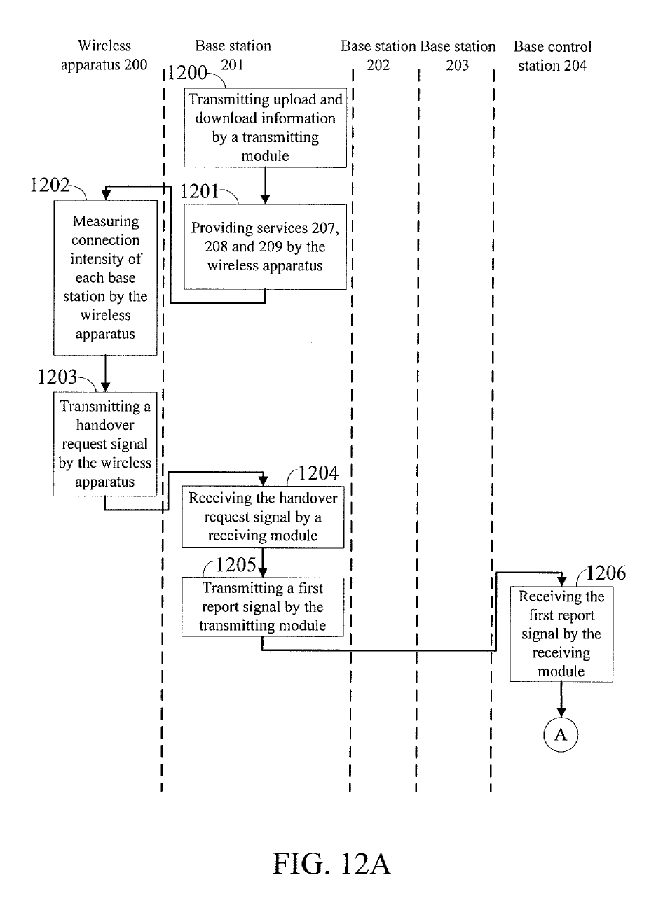

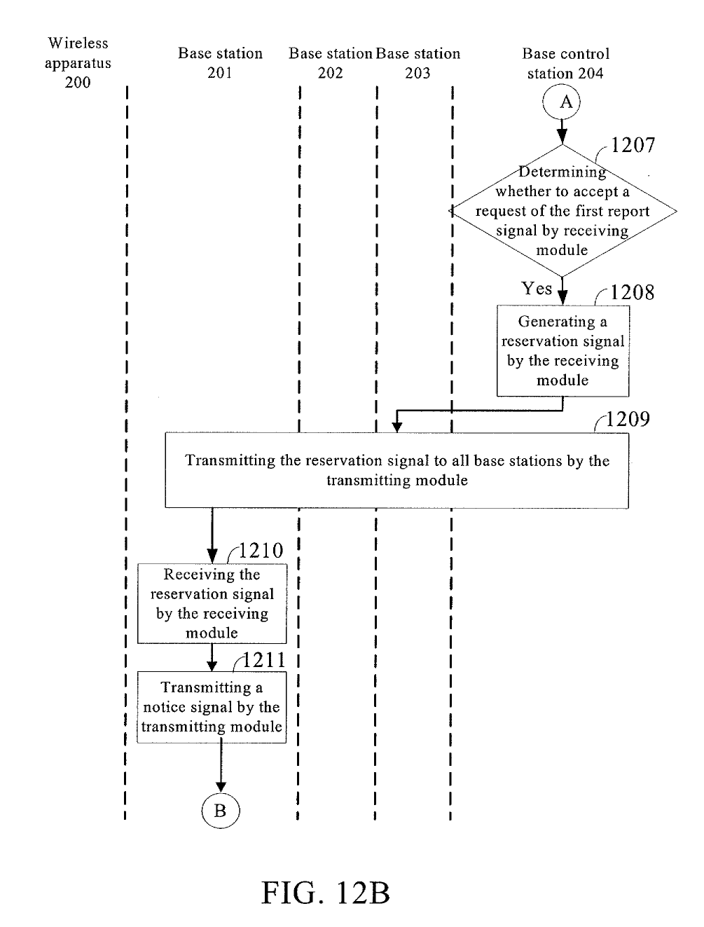

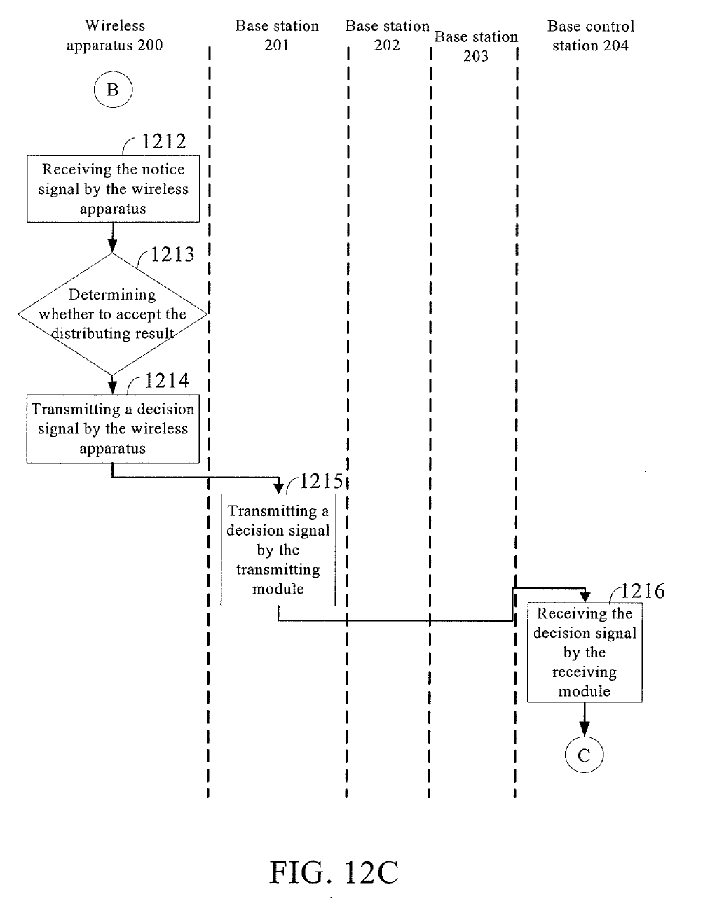

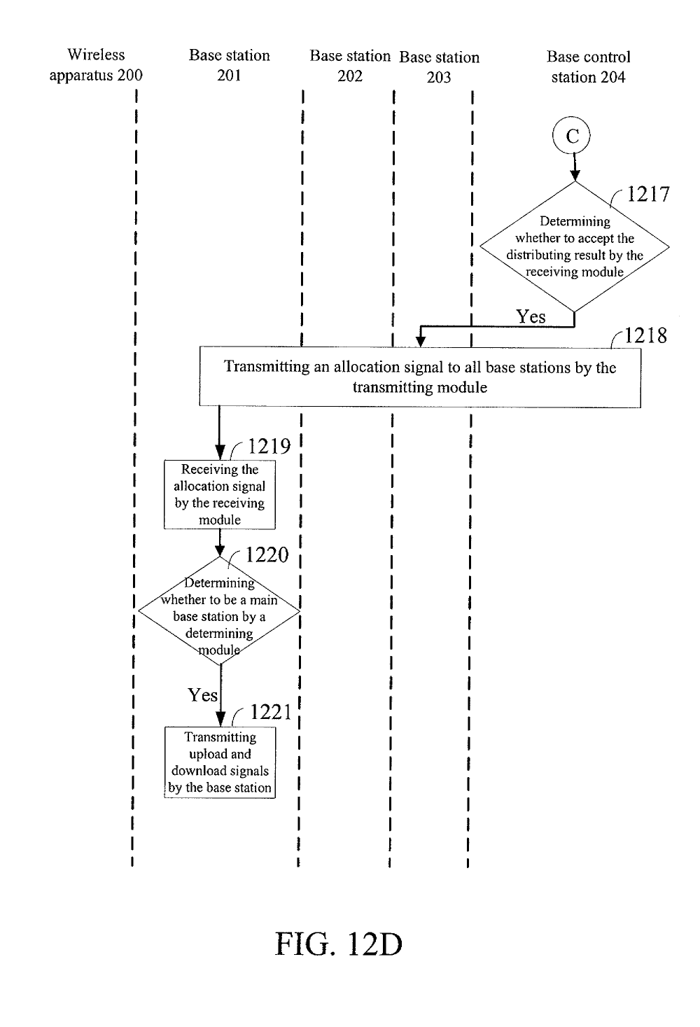

A ninth embodiment of the invention is shown in FIG. 12A, 12B, 12C and 12D which is a flow chart of a handover control method of a wireless network handover system 2 conforming to the WiMAX specification. The handover system comprises a wireless apparatus 200, a base station 201, a base station 202, a base station 203 and a base control station 204. In this embodiment, the base station 201 is a main base station. Consequently, step 1200 is executed to enable the base station 201 to provide an upload signal and a download signal for the wireless apparatus by the base station 201, wherein the upload signal comprises all necessary information related to uploading and the download signal comprises all necessary information related to downloading. The wireless apparatus can communicate with the base station 201, the base station 202 and the base station 203 according to the information. Detailed contents of the upload signal and the download signal are signals conforming to the WiMAX wireless network specification and no further descriptions are given here.

In the ninth embodiment, three services simultaneously provided by one base station are distributed to three different base stations via the handover operation as an example. In step 1201, the base station 201 provides services 207, 208 and 209 for the wireless apparatus. In step 1202, the wireless apparatus transmits measurement signals to detect connection intensity of base stations 201, 202 and 203, wherein a technique for detecting the connection intensity conforms to the WiMAX wireless network specification. After obtaining the connection intensity information of each base station, the wireless apparatus 200 can change the base station that provides service according to the connection intensity information of each base station. Next, step 1203 is executed to enable the wireless apparatus 200 for transmitting a handover request signal to the base station 201, wherein the handover request signal comprises the information of connection intensity of the wireless network, a service bandwidth and a data linking priority of the wireless apparatus. Next, step 1204 is executed to enable a third receiving module of the base station 201 for receiving the handover request signal. Later, step 1205 is executed to enable the transmitting module of the base station 201 for transmitting a first report signal to the base control station 204 according to the content of the handover request signal.

Next, step 1206 is executed to enable the receiving module of the base control station for receiving the first report signal. Next, step 1207 is executed to enable the receiving module of the base control station for determining whether to accept a request of the first report signal according to the information of the connection intensity of the wireless network, the service bandwidth and the data linking priority of the wireless network. The determination manners are shown as the following example. As aforementioned, assume that connection intensity of the wireless network of the base station 201 is 5 and its remaining resource is 2, connection intensity of the wireless network of the base station 202 is 10 and its remaining resource is 5, and connection intensity of the wireless network of the base station 203 is 15 and its remaining resource is 3; and the required resources and priorities of services 207, 208 and 209 are (6,3), (4,1) and (2,2)respectively. In the ninth embodiment, the priority with a smaller value means higher priority and the connection intensity of the wireless network with a larger value means stronger connection intensity. According to sorted priorities, the service 207, the service 208 and the service 209 are distributed to the base station 201, the base station 203 and the base station 202respectively. Next, considering the remaining resources of each base station. Consequently, the receiving module finally distributes service 207, the service 208 and the service 209 to the base station 201, the base station 202 and the base station 203respectively. Next, step 1208 is executed to enable the receiving module for generating a reservation signal. Later, step 1209 is executed to enable the transmitting module for transmitting the reservation signal to all base stations that provide services so that all base stations that provide services reserve necessary resources of services for providing. Step 1210 is executed to enable the receiving module of the base station 201 for receiving the reservation signal. Next, step 1211 is executed to enable the transmitting module of the base station 201 for transmitting a notice signal to the wireless apparatus according to the reservation signal so that the wireless apparatus receives a distributing result of the base control station.

Next, step 1212 is executed to enable the wireless apparatus for receiving notice signal. Step 1213 is executed for deciding whether to accept the distributing result of the base control station. If no, the handover request signal is transmitted continuously. If yes, the distributing result of the base control station is accepted and step 1214 is executed to enable the wireless apparatus for transmitting a decision signal to the base station 201. Next, step 1215 is executed to enable the transmitting module of the base station 201 for transmitting the decision signal to the base control station. Next, step 1216 is executed to enable the receiving module of the base control station for receiving the decision signal. Step 1217 is executed to enable the receiving module for determining whether the wireless apparatus accepts the distributing result of the base control station according to the decision signal. If no, the reserved resources on each base station are not allocated. If yes, step 1218 is executed to enable the transmitting module for transmitting an allocation signal to all base stations that provide services so that all base stations that provide services allocate the reserved resources. Next, step 1219 is executed to enable the receiving module of the base station 201 for receiving the allocation signal. Later, step 1220 is executed to enable the determining module of the base station 201 for determining whether the base station 201 is the main base station according to the allocation signal. If no, the upload signal and the download signal are stopped transmitting to the wireless apparatus. If yes, step 1221 is executed to enable the base station 201 for re-transmitting the upload signal and the download signal to the wireless apparatus so that the wireless apparatus can receive the upload and download signals of each of the base stations. Finally, services 207, 208 and 209 are separately provided by base stations 201, 202 and 203 to complete the handover operation.

In the ninth embodiment, if the handover request signal comprises the information of connection intensity only, the base control station can actively inform the wireless apparatus via the reservation signal to perform the handover operation for adjusting the base station that provides services 207, 208 and 209.

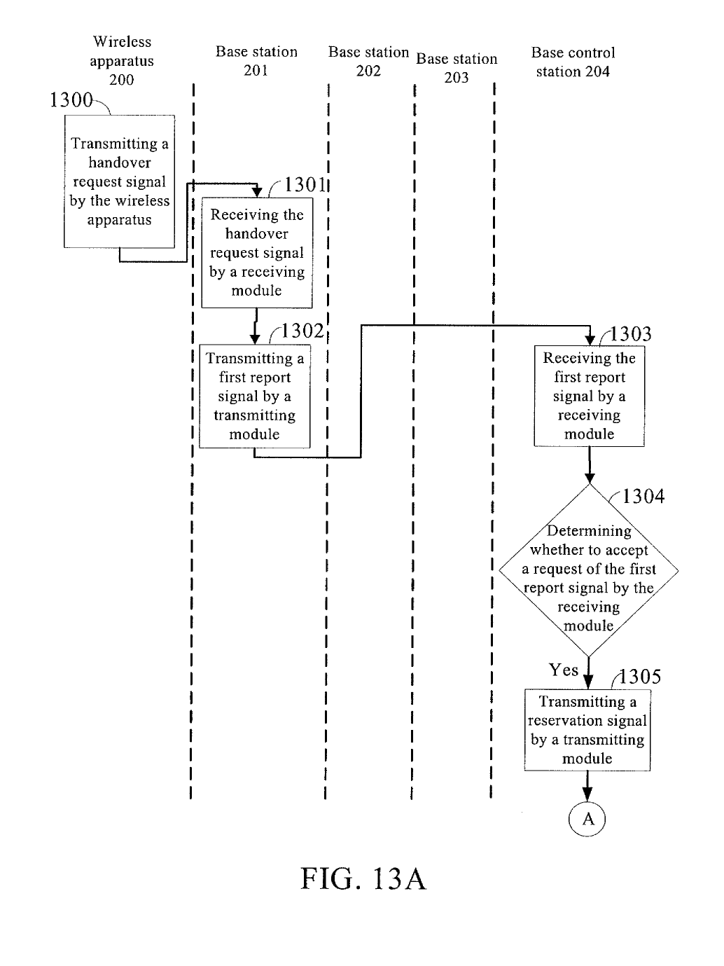

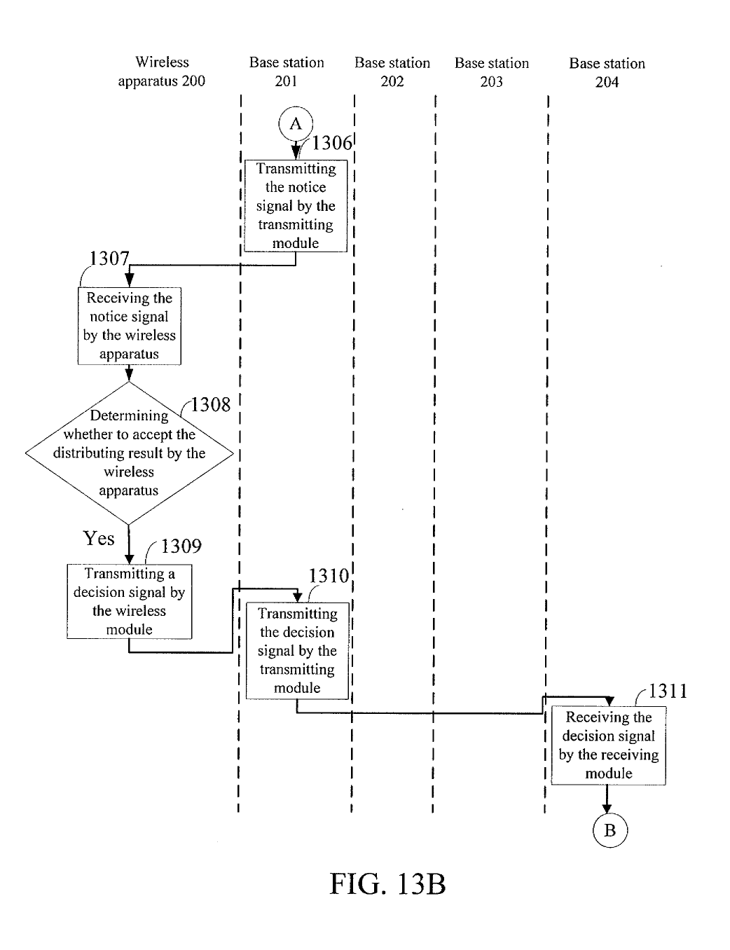

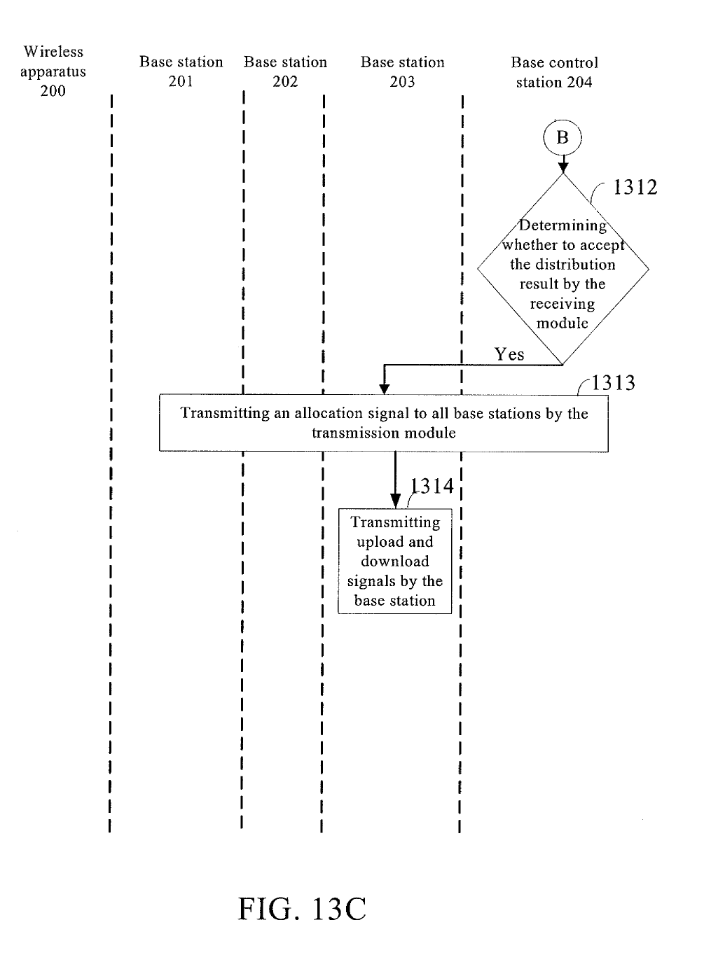

A tenth embodiment of the invention is shown in FIGS. 13A, 13B and 13C, which is a flow chart of a handover control method of a wireless network handover system 5 conforming to the WiMAX specification. The handover system comprises a wireless apparatus 200, a base station 201, a base station 202, a base station 203 and a base control station 204. In the tenth embodiment, a main base station is changed form a base station 201 to a base station 203 according to a handover operation as an example, and an initial state is that current services 207, 208 and 209 are provided by base stations 201, 202 and 203 respectively. The main base station is the base station 201.

Step 1300 is executed to enable the wireless apparatus 200 for transmitting a handover request signal 500 to the base station 201. Step 1301 is executed to enable a receiving module 300 of the base station 201 for receiving the handover request signal 500. Step 1302 is executed to enable a receiving module 301 of the base station 201 for transmitting a first report signal 501 to the base control station 204. Step 1303 is executed to enable a receiving module 400 of the base control station 204 for receiving the first report signal 501. Later, step 1304 is executed to enable the receiving module 400 for determining whether to accept a request of the first report signal 501 according to the information of connection intensity of the wireless network, a service bandwidth and a data linking priority of the wireless apparatus in the first report signal 501. If the request of the first report signal 501 is accepted, step 1305 is executed to enable a transmitting module 401 for transmitting a reservation signal 502 to the base station 201. Next, step 1306 is executed to enable the transmitting module 301 of the base station 201 for transmitting a notice signal 503 to the wireless apparatus 200 according to the reservation signal 502 so that the wireless apparatus 200 receives a distributing result of the base control station 204.

Next, step 1307 is executed to enable the wireless apparatus 200 for receiving the notice signal 503. Step 1308 is executed for determining whether to accept the distributing result of the base control station 204. If no, the handover request signal 500 is transmitted continuously If yes, the distributing result of the base control station 204 is accepted and step 1309 is executed to enables the wireless apparatus 200 for transmitting a decision signal 504 to the base station 201. Next, step 1310 is executed to enable the transmitting module 301 of the base station 201 for transmitting the decision signal 504 to the base control station 24. Next, step 1311 is executed to enable the receiving module 400 of the base control station 24 for receiving the decision signal 504. Next, step 1312 is executed to enable the receiving module 400 for determining whether the wireless apparatus 200 accepts the distributing result of the base control station 204 according to the decision signal 504. If no, the main base station is the base station 201. If yes, step 1313 is executed to enable a transmitting module 401 of the base control station 204 for transmitting an allocation signal 505 to all the base stations (comprising the base station 201, the base station 202 and the base station 203) so that all base stations receive a message that the main base station is changed from the base station 201 to the base station 203.

Next, step 1314 is executed to enable the base station 203 for transmitting an upload signal 506 and a download signal 507 to the wireless apparatus 200 so that the wireless apparatus 200 can understand current uploading and downloading conditions of each base station.

In the tenth embodiment, if the handover request signal 500 comprises the information of connection intensity only, the base control station 204 can actively inform the wireless apparatus 200 via the reservation signal 502 to perform the handover operation for adjusting the main base station that provides the upload signal 506 and the download signal 507.

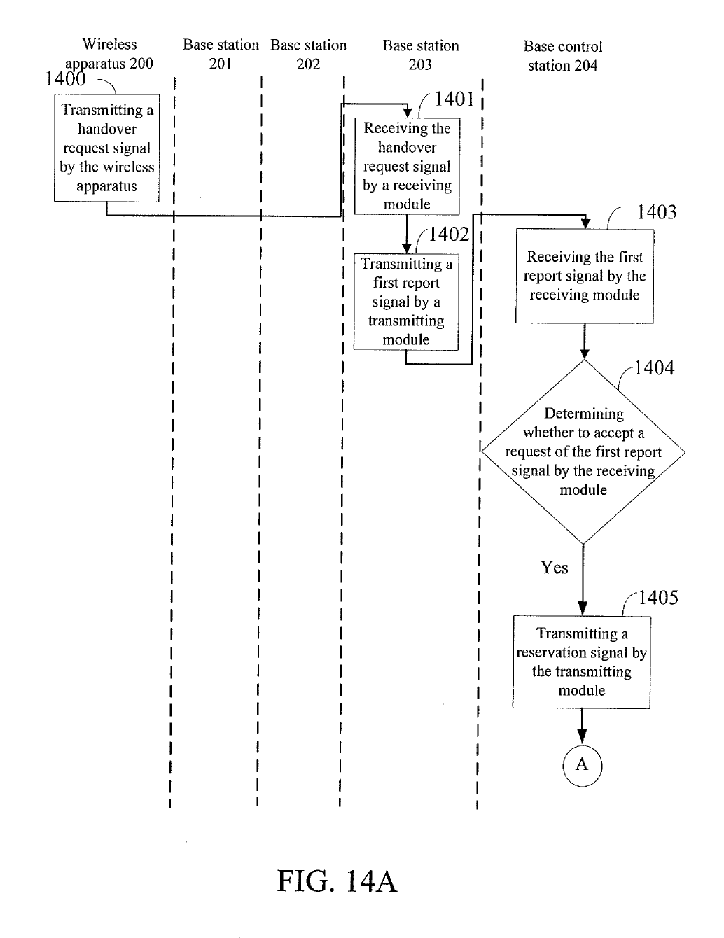

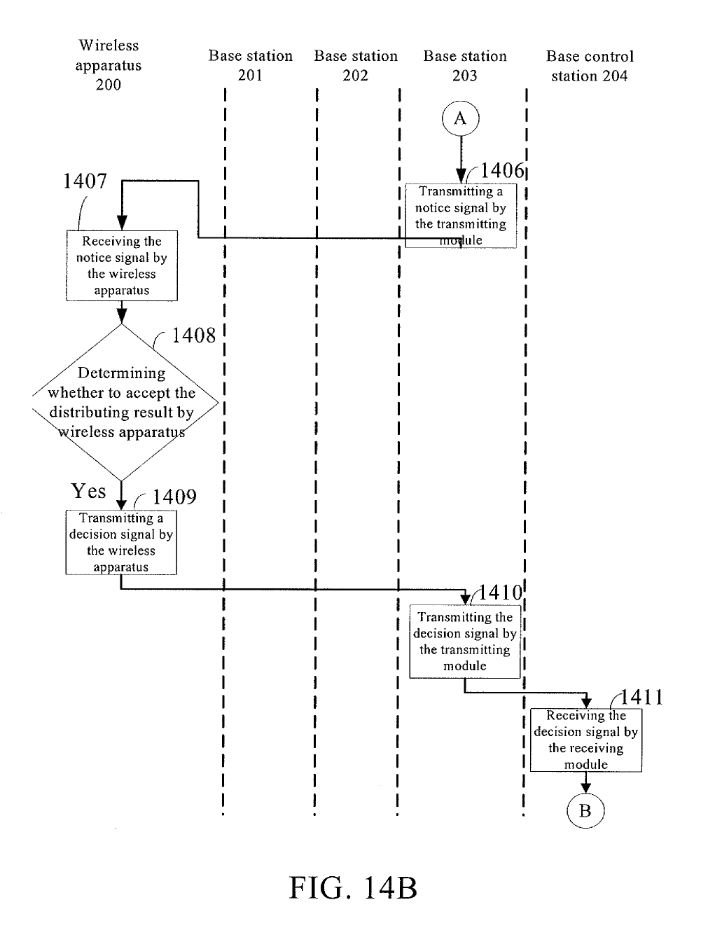

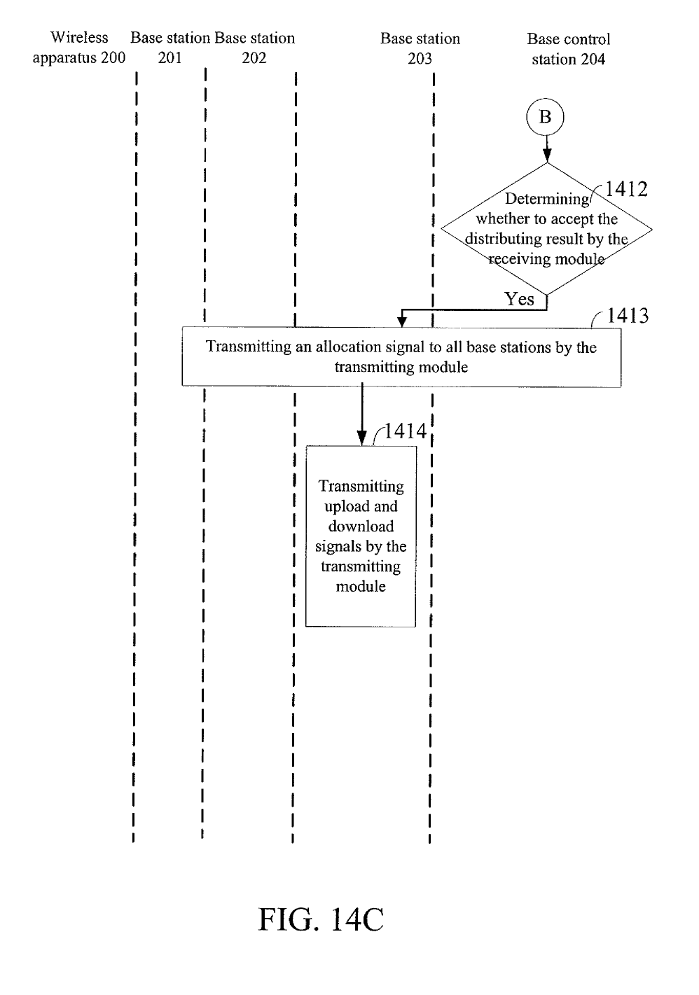

An eleventh embodiment of the invention is shown in FIG. 14A, 14B and 14C, which is a flow chart of a handover control method of a wireless network handover system 6 conforming to the WiMAX specification. The handover system comprises a wireless apparatus 200, a base station 201, a base station 202, a base station 203 and a base control station 204. In the eleventh embodiment, a base station 201 is changed to a base station 203 to provide a service 207 according to a handover operation as an example, and an initial state is that current services 207, 208 and 209 are provided by base stations 201, 202 and 203respectively. A main base station is the base station 203.

At first, step 1400 is executed to enable the wireless apparatus 200 for transmitting a handover request signal 600 to the base station 203. Step 1401 is executed to enable a receiving module 300 of the base station 203 for receiving the handover request signal 600. Step 1402 is executed to enable a transmitting module 301 of the base station 203 for transmitting a first report signal 601 to the base control station 204. Step 1403 is executed for receiving the first report signal 601. Step 1404 is executed to enable a receiving module 400 of the base control station 204 for determining whether to accept a request of the first report signal 601 according to the information of connection intensity of the wireless network, a service bandwidth and a data linking priority of the wireless apparatus in the first report signal 601 by the receiving module 400 of the base control station 204. If the request of the first report signal 601 is accepted, step 1405 is executed to enable a transmitting module 401 of the base control station 204 for transmitting a reservation signal 602 to the base station 203. Step 1406 is executed to enable a transmitting module 301 the base station 203 for transmitting a notice signal 603 to the wireless apparatus 200 according to the reservation signal 602 so that the wireless apparatus 200 receives a distributing result of the base control station 204.

Next, step 1407 is executed to enable the wireless apparatus 200 for receiving the notice signal 603. Step 1408 is executed for determining whether to accept the distributing result of the base control station 204. If no, the handover request signal 600 is transmitted continuously If yes, the distributing result of the base control station 204 is accepted and step 1409 is executed to enable the wireless apparatus 200 for transmitting a decision signal 604 to the base station 203. Step 1410 is executed to enable the transmitting module 301 of the base station 203 for transmitting the decision signal 604 to the base control station 204. Step 1411 is executed to enable the receiving module 400 of the base control station 204 for receiving the decision signal 604. Step 1412 is executed to enable the receiving module 400 for determining whether the wireless apparatus 200 accepts the distributing result of the base control station 204 according to the decision signal 604. If no, all base stations that provide services do not change. If yes, step 1413 is executed to enable the transmitting module 401 of the base control station 204 for transmitting an allocation signal 605 to all the base stations (comprising the base station 201, the base station 202 and the base station 203) so that all base stations confirm the base station that provides the service 207 is already changed from the base station 201 to the base station 203. Later, step 1414 is executed to enable the base station 203 for transmitting an upload signal 606 and a download signal 607 to the wireless apparatus 200 so that the wireless apparatus 200 can understand current uploading and downloading conditions of each base station. Finally, the base station 203 provides the service 207 and 209, and the base station 202 provides the service 208.

In the eleventh embodiment, if the handover request signal 600 comprises the information of connection intensity only, the base control station 204 can actively inform the wireless apparatus 200 via the reservation signal 602 to perform the handover operation for adjusting base stations that provide services 207, 208 and 209.

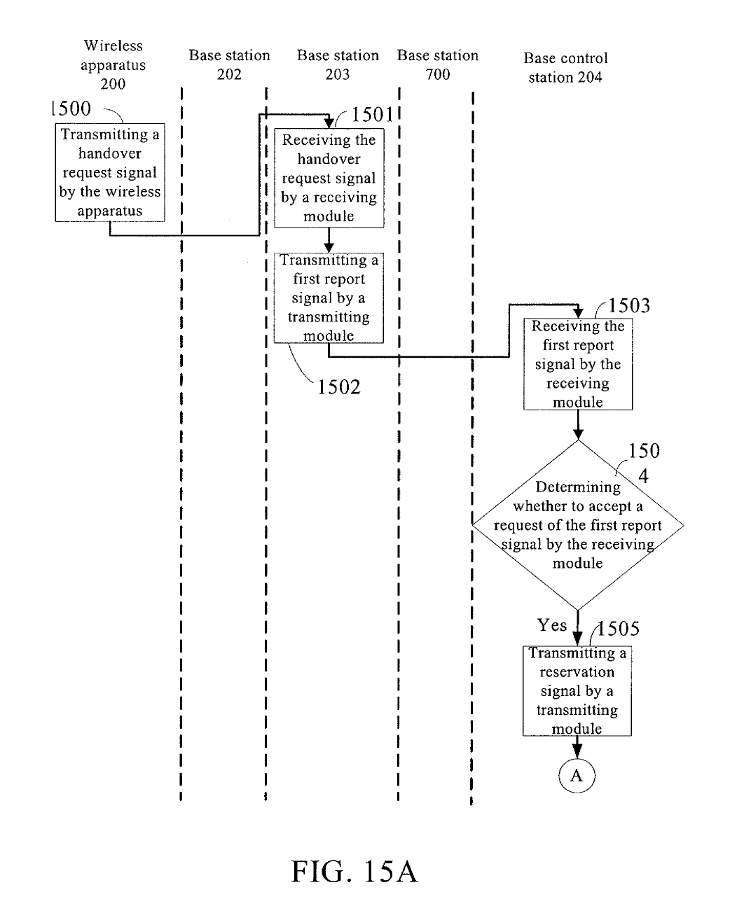

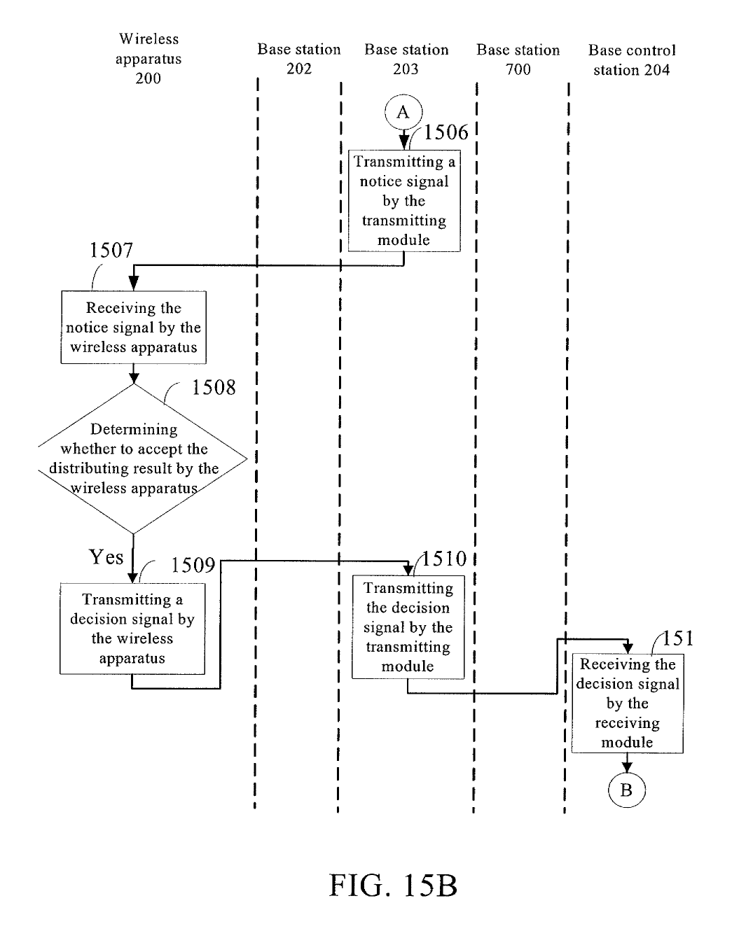

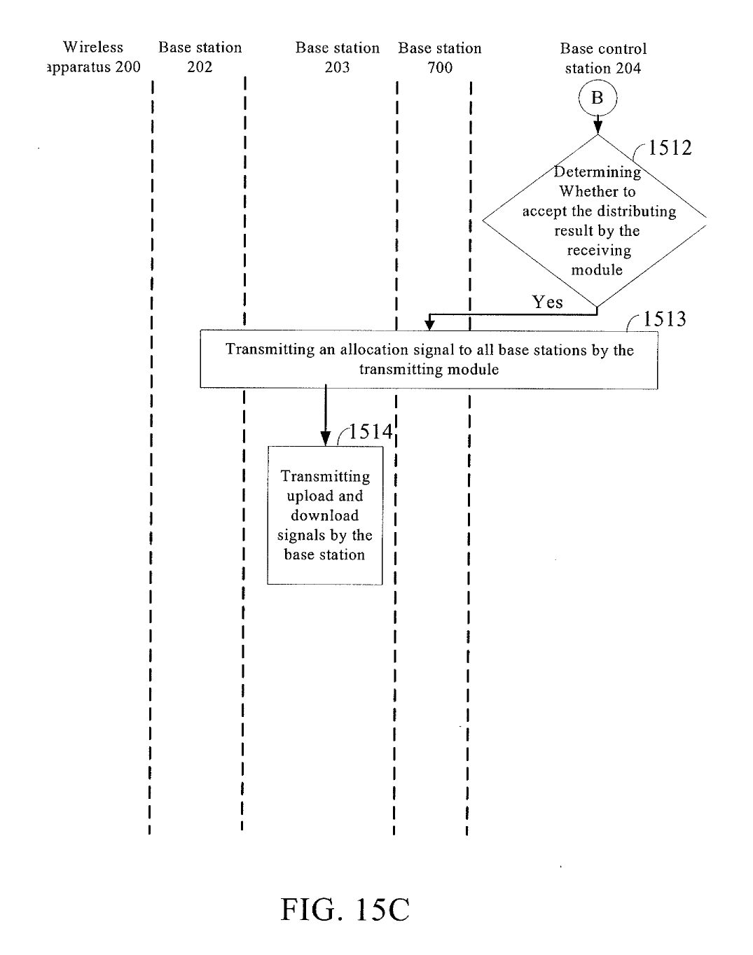

A twelfth embodiment of the invention is shown in FIG. 15A, 15B and 15C, which is a flow chart of a handover control method of a wireless network handover system 7 conforming to the WiMAX specification. The handover system comprises a wireless apparatus 200, a base station 700, a base station 202, a base station 203 and a base control station 204, wherein the base station 700 is the same as the base station 202 and the base station 203 and no further descriptions are given here. In the twelfth embodiment, the base station 203 for providing a service 209 is changed as the newly added base station 700 for providing a service 209 via a handover operation. An initial state is that current services 207 and 209 are provided by the base station 203, and a service 208 is provided by a base station 202. A main base station is the base station 203.

After the wireless apparatus 200 confirms the connection intensity information of the base station 202, the base station 203 and the base station 700, the wireless apparatus 200 can change the base station that provides services according to the connection intensity information of each base station. Consequently, step 1500 is executed to enable the wireless apparatus 200 for transmitting a handover request signal 705 to the base station 203. Step 1501 is executed to enable a receiving module 300 of the base station 203 for receiving the handover request signal 705. Step 1502 is executed to enable a transmitting module 301 of the base station 203 for transmitting a first report signal 706 to the base control station 204. Step 1503 is executed to enable a receiving module 400 of the base control station 204 for receiving the first report signal 706. Step 1504 is executed to enable the receiving module 400 of the base control station 204 for determining whether to accept a request of the first report signal 706 according to the information of connection intensity of the wireless network, a service bandwidth and a data linking priority of the wireless apparatus 200 in the first report signal 706. If the request of the first report signal 706 is accepted, step 1505 is executed to enable a transmitting module 401 of the base control station 204 for transmitting a reservation signal 707 to the base station 203 and the base station 700 to reserve the required resources for providing services. Step 1506 is executed to enable the transmitting module 300 of the base station 203 for transmitting a notice signal 708 to the wireless apparatus 200 according to the reservation signal 707 so that the wireless apparatus 200 receives a distributing result of the base control station 204.

Next, step 1507 is executed to enable the wireless apparatus 200 for receiving the notice signal 708. Step 1508 is executed to enable the wireless apparatus 200 for determining whether to accept the distributing result of the base control station 204. If no, the handover request signal 705 is transmitted continuously. If yes, the distributing result of the base control station 204 is accepted and step 1509 is executed to enable the wireless apparatus 200 for transmitting a decision signal 709 to the base station 203. Step 1510 is executed to enable the transmitting module 301 of the base station 203 for transmitting the decision signal 709 to the base control station 204. Step 1511 is executed to enable the receiving module 400 of the base control station 204 for receiving the decision signal 709. Step 1512 is executed to enable the receiving module 400 of the base control station 204 for determining whether the wireless apparatus 200 accepts the distributing result of the base control station 204 according to the decision signal 709. If no, all base stations that provide services do not change. If yes, step 1513 is executed to enable the transmitting module 401 of the base control station 204 for transmitting an allocation signal 710 to all the base stations (comprising the base station 700, the base station 202 and the base station 203) so that all base stations confirm that the base station that provides the service 209 is already changed from the base station 203 to the base station 700. Next, step 1514 is executed to enable the base station 203 for transmitting an upload signal 711 and a download signal 712 to the wireless apparatus 200 so that the wireless apparatus 200 can receive current uploading and downloading conditions of each base station. Finally, the base station 203 provides the service 207, the base station 202 provides the service 208, and the base station 700 provides the service 209.

In the twelfth embodiment, if the handover request signal 705 comprises the information of connection intensity only, the base control station 204 can actively inform the wireless apparatus 200 via the reservation signal 707 to perform the handover operation for adjusting base stations that provide services 207, 208 and 209.

The aforementioned methods can use a computer readable medium for storing a computer program to execute the aforementioned steps. The computer readable medium can be a floppy disk, a hard disk, an optical disk, a flash disk, a tape, a database accessible from a network or a storage medium with the same functionality that can be easily thought by people skilled in the art.

The invention can dynamically determine the base station that provides services so that the service of the wireless apparatus can be provide by the base station with better signal. If no base station can provide all services of the wireless apparatus, the invention can reserve services with higher priority to be provided by the base station depending on the priorities of each service. Consequently, the invention enables the resource of each base station to be utilized effectively and services required by users can be kept without incurring interrupt to further enhance a utilization ratio of all base stations.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A handover control method of a wireless network, comprising steps of:
receiving a report signal from a first service group;
determining whether the first service group needs update according to the report signal;
transmitting a reservation signal to a second service group for reserving the reservation resources of the second service group; and
transmitting an allocation signal to the first service group and the second service group for indicating the handover;
wherein each of the first service group and the second service group comprises a plurality of base stations for providing the services to a wireless apparatus.

2. The handover control method of claim 1, further comprising steps of:
receiving a first determining signal from the first service group; and
determining whether the second service group is accepted by the wireless apparatus according to the first determining signal.

3. The handover control method of claim 1, wherein the wireless apparatus and the base stations are adapted to providing service of orthogonal frequency division multiple access.

4. The handover control method of claim 1, wherein the wireless apparatus connects to the base stations, uploads the data and downloads the data simultaneously.

5. The handover control method of claim 1, wherein the report signal indicates at least one of the connection intensity of the wireless network, the service bandwidth, and the data linking priority of the wireless apparatus.

6. The handover control method of claim 1, wherein the wireless apparatus is one of a cell phone, a personal digital assistant, a notebook, and a combination thereof.

7. A handover control apparatus of a wireless network, comprising:
a receiving module for receiving a report signal from a first service group and determining whether the first service group needs update according to the report signal; and
a transmitting module for transmitting a reservation signal to a second service group to reserve the service resources of the second service group and transmitting an allocation signal to the first service group and the second service group to indicate the bandover;
wherein each of the first service group and the second service group comprises a plurality of base stations for providing the services to a wireless apparatus.

8. The handover control apparatus of claim 7, wherein the receiving module receives a first determining signal from the first service group and determines whether the second service group is accepted by the wireless apparatus according to the first determining signal.

9. The handover control apparatus of claim 7, wherein the wireless apparatus and the base stations are adapted to providing service of orthogonal frequency division multiple access.

10. The handover control apparatus of claim 7, wherein the wireless apparatus connects to the base stations, uploads the data and downloads the data simultaneously.

11. The handover control apparatus of claim 7, wherein the report signal indicates at least one of the connection intensity of the wireless network, the service bandwidth, and the data linking priority of the wireless apparatus.

12. The handover control apparatus of claim 7, wherein the wireless apparatus is one of a cell phone, a personal digital assistant, a notebook, and a combination thereof

13. A computer readable medium storing a computer program to execute a handover control method of a wireless network, the handover method comprising steps of:
receiving a report signal from a first service group;
determining whether the first service group needs update according to the report signal;
transmitting a reservation signal to a second service group for reserving the reservation resources of the second service group; and
transmitting an allocation signal to the first service group and the second service group for indicating the handover;
wherein each of the first service group and the second service group comprises a plurality of base stations for providing the services to a wireless apparatus.

14. The computer readable medium of claim 13,wherein the method further comprises steps of.
receiving a first determining signal from the first service group; and
determining whether the second service group is accepted by the wireless apparatus according to the first determining signal.

15. The computer readable medium of claim 13, wherein the wireless apparatus and the base stations are adapted to providing service of orthogonal frequency division multiple access.

16. The computer readable medium of claim 13, wherein the wireless apparatus connects to the base stations, uploads the data and downloads the data simultaneously.

17. The computer readable medium of claim 13, wherein the report signal indicates at least one of the connection intensity of the wireless network, the service bandwidth, and the data linking priority of the wireless apparatus.

18. The computer readable medium of claim 13, wherein the wireless apparatus is one of a cell phone, a personal digital assistant, a notebook, and a combination thereof.

19. A handover method of a wireless network, comprising steps of:
receiving a reservation signal;
transmitting a notice signal to a wireless apparatus according to the reservation signal;
receiving an allocation signal; and
determining whether the wireless network services of the wireless apparatus needs to be changed according to the allocation signal.

20. The handover method of claim 19, further comprising steps of:
receiving a handover request signal; and
transmitting a first report signal to a handover control apparatus according to the handover request signal.

21. The handover method of claim 19, wherein the wireless network services are services of orthogonal frequency division multiple access.

22. The handover method of claim 19, wherein the wireless apparatus connects to the base stations, uploads the data and downloads the data simultaneously.

23. The handover method of claim 19, wherein the wireless apparatus is one of a cell phone, a personal digital assistant, a notebook, and a combination thereof.

24. A handover apparatus of a wireless network, comprising:
a receiving module for receiving a reservation signal and an allocation signal;
a transmitting module for transmitting a notice signal to a wireless apparatus according to the reservation signal; and
a determining module for determining whether the wireless network services of the wireless apparatus needs to be changed according to the allocation signal.

25. The handover apparatus of claim 24, wherein the receiving module receives a handover request signal, and the transmitting module transmits a first report signal to a handover control apparatus according to the handover request signal.

26. The handover apparatus of claim 24, wherein the wireless network services are services of orthogonal frequency division multiple access.

27. The handover apparatus of claim 24, wherein the wireless apparatus connects to the base stations, uploads the data and downloads the data simultaneously.

28. The handover apparatus of claim 24, wherein the wireless apparatus is one of a cell phone, a personal digital assistant, a notebook, and a combination thereof.

29. A computer readable medium storing a computer program to execute a handover method of a wireless network, the handover method comprising steps of:
receiving a reservation signal;
transmitting a notice signal to a wireless apparatus according to the reservation signal;
receiving an allocation signal; and
determining whether the wireless network services of the wireless apparatus needs to be changed according to the allocation signal.

30. The computer readable medium of claim 29, the method further comprising steps of:
receiving a handover request signal; and
transmitting a first report signal to a handover control apparatus according to the handover request signal.

31. The computer readable medium of claim 29, wherein the wireless network services are services of orthogonal frequency division multiple access.

32. The computer readable medium of claim 29, wherein the wireless apparatus connects to the base stations, uploads the data and downloads the data simultaneously.

33. The computer readable medium of claim 29, wherein the wireless apparatus is one of a cell phone, a personal digital assistant, a notebook, and a combination thereof.
